(19) United States
(12) Patent Application Publication
(10) Pub. No.: US 2026/0299449 A1
(43) Pub. Date: Oct. 1, 2026

(54) TONER

(71) Applicant: CANON KABUSHIKI KAISHA, Tokyo (JP)

(72) Inventors: TATSUYA SAEKI, Shizuoka (JP); YUHEI TERUI, Shizuoka (JP); KENJI AOKI, Shizuoka (JP); SHUHEI IWASAKI, Kanagawa (JP); KAHO YAMADA, Shizuoka (JP)

(21) Appl. No.: 19/576,288

(22) Filed: Mar. 24, 2026

(30) Foreign Application Priority Data
Mar. 28, 2025 (JP) 2025-055537

(51) Int. Cl. G03G 9/087; C08L 25/14; C08L 33/06; G03G 9/093

(52) U.S. Cl. CPC G03G 9/0874; C08L 25/14; C08L 33/062; G03G 9/08706; G03G 9/08755; G03G 9/09328; G03G 9/09364; C08L 2203/20; C08L 2205/03

(57) ABSTRACT

A toner comprising a toner particle that comprises a binder resin, the binder resin comprising a crystalline vinyl resin and an amorphous resin; the amorphous resin comprising an amorphous polyester resin; the toner particle being covered with the amorphous polyester resin; the crystalline vinyl resin comprising a monomer unit (A) having specific structure, when an SP value of the crystalline vinyl resin is taken as SP(A), the SP(A) is within a specific range; and, in TOF-SIMS using the toner particle as a sample, the maximum value A(max) and the minimum value A (min) of the amount of ions corresponding to the monomer unit (A), detected in a specific region of the toner particles, satisfy a specific relationship.

### BACKGROUND

### Field of the Technology

The present disclosure relates to a toner for developing an electrostatic image used in an image forming apparatus for electrophotographic and electrostatic printing, or the like.

### Description of the Related Art

In recent years, there has been a widespread demand for reducing the energy consumption of electrophotographic image forming apparatuses. From the viewpoint of reducing the energy consumption, it is essential to lower the temperature of a fixing unit of an electrophotographic image forming apparatus, and a so-called “low-temperature fixability” for fixing a toner at a low temperature is important. For achieving “low-temperature fixability”, it is effective to lower the melting temperature of the toner and to lower the viscosity during melting, but this often involves trade-offs with “release property” and “durability”. Thus, techniques to satisfy all of these requirements are important.

With respect to these required performances, WO 2013/047296 discloses that the addition of a large amount of a wax having high compatibility as a plasticizer to a toner plasticizes a binder resin and can enhance the low-temperature fixability.

Japanese Patent Publication No. 2014-130243 discloses that the addition of a large amount of a crystalline vinyl resin that is instantaneously melted at a high temperature as a binder resin in the toner suppresses the reduction in low-temperature fixability and the reduction in viscosity during melting even in a higher-process-speed main body.

Japanese Patent Publication No. 2020-173414 discloses that incorporating a highly polar hydrophilic monomer into a crystalline vinyl resin as a binder resin facilitates phase separation between the crystalline vinyl resin and the release agent, thereby achieving both low-temperature fixability and release property.

Japanese Patent Publication No. 2019-219647 discloses that placing an amorphous polyester resin on the surface of crystalline vinyl resin to suppress the exposure of crystalline vinyl resin to the toner surface can improve durability.

However, when a large amount of a wax having high compatibility is added into the toner, as disclosed in WO 2013/047296, low-temperature fixability may not be sufficiently satisfied in a higher-process-speed main body in some cases. Further, when the wax is melted at a high temperature, the viscosity thereof is prone to decrease, and the release property is not sufficiently satisfied in some cases.

When a large amount of a crystalline vinyl resin is added, as disclosed in Japanese Patent Publication No. 2014-130243, the phase separation property with the release agent is prone to decrease, and the release property may not be sufficiently satisfied.

As disclosed in Japanese Patent Publication No. 2020-173414, when a highly polar hydrophilic monomer is used, the hydrophilic monomer exhibits high reactivity during polymerization. This tendency leads to a structure where the distribution of highly polar segments is concentrated within the crystalline vinyl resin, making it easier for the toner to exhibit a specific polar distribution. Therefore, when the toner is produced in an aqueous medium, the toner is likely to have a structure that the hydrophobic segments where many alkyl groups and the like are present within the crystalline vinyl resin tend to exist internally in the toner, and a surface layer mainly composed of hydrophilic segments where many polar groups exist. As a result, the release agent and the crystalline vinyl resin present inside the toner become more compatible with each other, and, in particular, the release property in a high temperature and high humidity environment may not be sufficiently satisfied in some cases. The existence of many hydrophobic segments, such as alkyl groups, in the crystalline vinyl resin inside the toner tends to reduce toner strength, which may result in insufficient durability, particularly in a high temperature and high humidity environment.

In the case where an amorphous polyester resin is added as a resin for a shell, as disclosed in Japanese Patent Publication No. 2019-219647, when the distribution of the crystalline vinyl resin is concentrated in a specific region inside the toner, the release property and durability in a high temperature and high humidity environment may not be fully satisfied in some cases.

As described above, the toner using a crystalline vinyl resin comprising a hydrophilic monomer as a binder resin may be difficult to achieve both the release property and the durability in a high temperature and high humidity environment.

### SUMMARY

The present disclosure directs to provide a toner capable of achieving all of excellent low-temperature fixability, and an excellent release property, durability, and charge rising performance in a high temperature and high humidity environment.

According to at least one aspect of the present disclosure, there is provided a toner comprising a toner particle that comprises a binder resin,
the binder resin comprising a crystalline vinyl resin and an amorphous resin;
the amorphous resin comprising an amorphous polyester resin;
the toner particle being covered with the amorphous polyester resin;
the crystalline vinyl resin comprising a monomer unit (A) represented by formula (A) below:

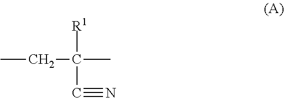

in formula (A), R¹ represents a hydrogen atom or a methyl group;
when an SP value of the crystalline vinyl resin is taken as SP(A) [(J/cm³)^{0.5}] the SP(A) is from 19.0 to 22.5 (J/cm³)^{0.5}; and
in a chart with an x-axis representing time and a y-axis representing ion amounts corresponding to the monomer unit (A), obtained by analyzing the toner particle while performing sputtering up to a sputtering time to remove 20 nm of a polymethyl methacrylate standard sample film in a time-of-flight secondary ion mass spectrometry (TOF-SIMS) using the toner particle as a sample,
when a maximum value of the ion amount is taken as A(max) and a minimum value of the ion amount is taken as A (min), the A(max) and the A (min) satisfy expression (1) below.

$$1. < [ A ( max ) / A ( min ) ] \leq 3. \qquad ( 1 )$$

According to at least one aspect of the present disclosure, a toner capable of achieving all of excellent low-temperature fixability, and an excellent release property, durability, and charge rising performance in a high temperature and high humidity environment can be provided.

Features of the present disclosure will become apparent from the following description of embodiments. The following description of embodiments is described by way of example.

### DESCRIPTION OF THE EMBODIMENTS

In the present disclosure, the expression of “from XX to YY” or “XX to YY” indicating a numerical range means a numerical range including a lower limit and an upper limit which are end points, unless otherwise specified. Also, when a numerical range is described in a stepwise manner, the upper and lower limits of each numerical range can be arbitrarily combined. In the present disclosure, for example, descriptions such as “at least one selected from the group consisting of XX, YY and ZZ” mean any of XX, YY, ZZ, the combination of XX and YY, the combination of XX and ZZ, the combination of YY and ZZ, and the combination of XX, YY, and ZZ. Here, when XX is a group, a plurality of XXs may be selected, and the same applies to YY and ZZ.

In the present disclosure, the “monomer unit” refers to the reacted form of a monomer substance in a polymer. For example, one carbon-carbon bond section in the main chain in the polymer in which the polymerizable monomer has been polymerized is defined as one unit. The polymerizable monomer can be represented by the following formula.

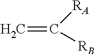

In the formula, R_{A} represents a hydrogen atom or an alkyl group (preferably an alkyl group having from 1 to 3 carbon atoms, and more preferably a methyl group), and R_{B} represents an arbitrary substituent.

In the present disclosure, the crystalline vinyl resin is a resin that exhibits a clear endothermic peak in differential scanning calorimeter (DSC) measurement.

Hereinafter, the toner will be described in detail.

The present inventors have found that the following constitution can solve the problem described above.

That is, the toner of the present disclosure is a toner comprising a toner particle that comprises a binder resin, the binder resin comprises a crystalline vinyl resin and an amorphous resin. The amorphous resin comprises an amorphous polyester resin, and the toner particle is covered with the amorphous polyester resin. The crystalline vinyl resin comprises a monomer unit (A) represented by formula (A) below.

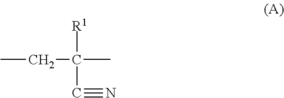

In formula (A), R¹ represents a hydrogen atom or a methyl group.

When an SP value of the crystalline vinyl resin is taken as SP(A) [(J/cm³)^{0.5}] the SP(A) is from 19.0 to 22.5 (J/cm³)^{0.5}.

In addition, in a chart with an x-axis representing time and a y-axis representing ion amounts corresponding to the monomer unit (A), obtained by analyzing the toner particle while performing sputtering up to a sputtering time to remove 20 nm of a polymethyl methacrylate standard sample film in a time-of-flight secondary ion mass spectrometry (TOF-SIMS) using the toner particle as a sample, when a maximum value of the ion amount is taken as A(max) and a minimum value of the ion amount is taken as A (min), the A(max) and the A (min) satisfy expression (1) below.

1.0<[A(max)/A(min)]≤3.0 (1)

The binder resin comprised in the toner particle comprises a crystalline vinyl resin and an amorphous resin, and the crystalline vinyl resin has a monomer unit (A) represented by formula (A) above. That is, the binder resin comprises a crystalline vinyl resin comprising the monomer unit (A). The toner particle is preferably suspension-polymerized toner particle.

Monomer unit (A) is a monomer unit formed by vinyl polymerization of acrylonitrile, methacrylonitrile, or the like, for example.

Since the monomer unit (A) has high polarity, a crystalline vinyl resin comprising the monomer unit (A) forms a structure in which the distribution of highly polar segments in the crystalline vinyl resin is concentrated. As a result, the degree of crystallinity of the crystalline vinyl resin is increased, an excellent sharp melt property is developed, and the low-temperature fixability can be improved. In addition, the phase separation property from the release agent is increased, and the release property and the durability can be improved.

In particular, if a toner is produced in an aqueous medium using a crystalline vinyl resin comprising a highly hydrophilic monomer unit, the distribution of the crystalline vinyl resin is likely to be concentrated on the surface and regions in the vicinity of the surface of the toner particle due to the hydrophilicity of the monomer units. As a result, the durability of the toner and the charge rising performance may decrease.

In order to prevent a decrease in durability and charge rising performance as described above, it is important that the binder resin comprises an amorphous polyester resin as an amorphous resin and the toner particle is covered with the amorphous polyester resin.

For example, the toner has a core-shell structure composed of a core comprising a crystalline vinyl resin and a shell comprising an amorphous polyester resin, the shell covering the core. Preferably, the toner has a core-shell structure composed of a core comprising a crystalline vinyl resin and an amorphous vinyl resin and a shell comprising an amorphous polyester resin, the shell covering the core.

Covering the surface of the toner particle with an amorphous polyester resin can suppress the exposure of the crystalline vinyl resin to the toner surface due to the hydrophilicity of the monomer unit (A). As a result, charge rising performance and durability can be improved.

Meanwhile, the toner particle covered with an amorphous polyester resin is likely to exhibit the distribution of polar segments of the crystalline vinyl resin having a high affinity for the amorphous polyester resin that covers the toner particle surface concentrated on the toner surface and in the vicinity of the toner surface, in particular, when the toner particle is produced particularly in an aqueous medium. As a result, the durability and the release property of the toner may decrease.

In order to solve this problem, the present inventors have studied a method of uniformly dispersing the polar segments of the crystalline vinyl resin comprising a monomer unit (A) in a toner particle. As a result, the present inventors have found that this problem can be solved by controlling the ion amount corresponding to the monomer unit (A) in the specific region of the toner particle as detected by time-of-flight secondary ion mass spectrometry (TOF-SIMS) using the toner particle as a sample to a specific value.

In the time-of-flight secondary ion mass spectrometry (TOF-SIMS) using a toner particle as a sample, the toner particle is analyzed while sputtering the toner particle up to a sputtering time to remove 20 nm from a polymethyl methacrylate (PMMA) standard sample film. When a maximum value of the ion amount is taken as A(max) and a minimum value of the ion amount is taken as A (min) in a chart with an x-axis representing time and a y-axis representing the ion amounts corresponding to the monomer unit (A), obtained by the above analysis, the A(max) and the A (min) satisfy expression (1) below.

$$1. < [ A ( max ) / A ( min ) ] \leq 3. \qquad ( 1 )$$

Usually, TOF-SIMS is a surface analysis method, and the data in the depth direction is the data in the region from the surface to approximately 1 nm depth. In the present disclosure, the measurement is performed while sputtering the toner particle in order to analyze a deeper region by TOF-SIMS.

Specifically, in order to analyze the region from the surface of the toner particle toward the inside of the particle up to 20 nm, a TOF-SIMS analysis of the toner particle is performed while sputtering the toner particle up to a sputtering time to remove 20 nm of a polymethyl methacrylate (PMMA) standard sample film. An analysis in such conditions makes it possible to determine the ion amount corresponding to the monomer unit (A) in the region from the toner particle surface to 20 nm toward the inside of the particle.

Since the monomer unit (A) has a high polarity, the distribution state of the highly polar segments of the toner particle can be checked by measuring an ion amount corresponding to the monomer unit (A).

As described above, the distribution of the highly polar component in the toner particle is likely to be concentrated on the surface and in the vicinity of the surface of the toner particle. Therefore, the change in polarity of the toner particle is the greatest on the surface and in the region in the vicinity of the surface.

That is, it can be said that if the variation in the distribution of highly polar segments is small in the region on the surface or in the vicinity of the surface of the toner particle with the largest change in polarity, the variation in the distribution of highly polar segments in the whole toner particle is small, and the distribution of polarity is uniform.

A(max) represents an ion amount corresponding to the monomer unit (A) in the region where the amount of the existing polar segments of the crystalline vinyl resin is largest in the region from the toner particle surface to 20 nm toward the inside of the particle. A (min) represents an ion amount corresponding to the monomer unit (A) in the region where the amount of the polar segments of the crystalline vinyl resin is smallest in the above region.

It is important that the value of A(max)/A (min) calculated from these values is greater than 1.0 and not greater than 3.0. When the value of A(max)/A (min) is 1.0, the shell is thick, making it likely to impede heat conduction into the interior of the toner particle, or the shell is nearly absent, making it likely to expose the crystalline vinyl resin to the toner surface. As a result, all of the low-temperature fixability, and the durability and the charge rising performance in a high-temperature and high-humidity environment are difficult to achieve.

The value of A(max)/A (min) is more preferably 2.5 or less, and still more preferably 2.0 or less.

The value of A(max)/A (min) is preferably as low as possible in order to make the distribution of the polar segments of the crystalline vinyl resin in the toner particle uniform, but is preferably 1.1 or more, and more preferably 1.2 or more, from the viewpoint of not impeding heat conduction into the interior of the toner particle.

The value of A(max)/A (min) is preferably from 1.1 to 3.0, preferably from 1.2 to 3.0, more preferably from 1.2 to 2.5, and still more preferably from 1.2 to 2.0. It is preferable that A(max) and A (min) satisfy expression (6) below.

$$1.2 \leq [ A ( max ) / A ( min ) ] \leq 3. \qquad ( 6 )$$

A value of A(max)/A (min) greater than 1.0 and not greater than 3.0 indicates that the variation in the ion amount corresponding to the monomer unit (A) is within a certain range in the region from the toner particle surface to 20 nm toward the inside of the particle.

That is, A(max)/A (min) within the above range indicates that the variation in the distribution of polar segments of the crystalline vinyl resin is suppressed to a certain range in the region on the surface and in the vicinity of the surface of the toner particle. A small variation in the distribution of highly polar segments in the region on the surface and in the vicinity of the surface of the toner particle with the largest change in polarity indicates that the distribution of highly polar segments in the whole toner particle is uniform.

The reduced variation in the distribution of polar segments in the crystalline vinyl resin leads to a reduced variation in the distribution of hydrophobic segments in the crystalline vinyl resin inside the toner particle. As a result, the phase separation property with the release agent existing inside the toner particle increases, thereby improving the release property.

Further, the uniform existence of highly polar segments in the whole toner particle enhances the strength of the toner particle, enabling the production of a durable toner that resists the formation of white streaks through a durability test, even in a high temperature and high humidity environment. Further, the existence of highly polar segments in the whole toner particle makes it difficult for charges generated on the toner surface to dissipate to other components and enables rapid charging in the whole toner, resulting in good charge rising performance, even in a high temperature and high humidity environment.

The value of A(max)/A (min) can be controlled by the structure and the amount of the crystalline vinyl resin, the structure and the amount of the amorphous polyester resin, and the method of producing the toner particle. For example, the value of A(max)/A (min) can be reduced by increasing the acid value of the amorphous polyester resin or increasing the pH during the toner production. In addition, the value of A(max)/A (min) can be increased by lowering the SP value of the amorphous polyester resin.

When an SP value of the crystalline vinyl resin is taken as SP(A) [(J/cm³)]^{0.5}] the SP(A) is from 19.0 to 22.5 (J/cm³)^{0.5}.

An SP(A) within this range can increase the melting speed at or above the melting temperature and improve the low-temperature fixability because the degree of crystallinity of the toner becomes high. In addition, the phase separation property between the crystalline vinyl resin and the release agent, such as ester wax, is enhanced, and the release property can be improved even in a high temperature and high humidity environment.

The SP(A) [(J/cm³)^{0.5}] is preferably from 19.5 or larger, more preferably 20.0 or larger, and still more preferably 21.0 or larger. An SP(A) within this range increases the phase separation property between the crystalline vinyl resin and easily improves the release property.

In addition, SP(A) [(J/cm³)^{0.5}] is preferably 22.0 or less, and more preferably 21.5 or less. Within this range, the crystalline vinyl resin in the vicinity of the surface of the toner can be reduced, and the durability and the charge rising performance are likely to be better.

The SP(A) [(J/cm³)^{0.5}] can be controlled by the proportion of the hydrophilic monomers in the crystalline vinyl resin, or the like. The SP(A) becomes large when the proportion of hydrophilic monomers in the crystalline vinyl resin is high, and becomes small when the proportion of hydrophilic monomers is low. For example, the SP(A) can be controlled within the above range by setting the proportion of hydrophilic monomers, such as an acrylic nitrile monomer, to 5 to 20% by mass in the crystalline vinyl resin.

As described above, the present inventors have repeated studies on the above problems and, as a result, have found that the problems can be solved by the following constitution.

That is, the present inventors have is found that a toner particle comprising a crystalline vinyl resin comprising a specific highly polar monomer unit and being covered with an amorphous polyester resin can provide a toner with a specific configuration in which polar segments in the crystalline vinyl resin are allowed to exist uniformly in the toner, and the toner having the above specific constitution can solve the above problem. Specifically, this constitution makes it possible to provide a toner that can achieve all of excellent low-temperature fixability and the release property, the durability, and the charge rising performance even in a high temperature and high humidity environment.

The crystalline vinyl resin preferably comprises 50.0 to 85.0% by mass of a monomer unit (A2) represented by formula (A2) below.

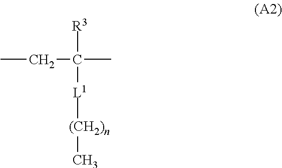

In formula (A2), R³ is a hydrogen atom or a methyl group, L¹ is a single bond, an ester bond (preferably the carbonyl group in the ester bond is bonded to the carbon atom to which R³ is bonded), or an amide bond, and n is an integer of from 15 to 30.

A content proportion of the monomer units (A2) in the crystalline vinyl resin within the above range increases the crystallinity of the crystalline vinyl resin and facilitates the control of the SP value (SP(A)) of the crystalline vinyl resin to be within the range described above. As a result, the low-temperature fixability, the durability, the release property, and the charge rising performance can be further improved.

The crystalline vinyl resin comprises preferably 55.0% by mass or more, more preferably 60.0% by mass or more, of the monomer unit (A2). Within this range, crystallinity of the crystalline vinyl resin is further increased, and both the low-temperature fixability and the durability can be achieved.

The crystalline vinyl resin comprises preferably 80.0% by mass or less, more preferably 70.0% by mass or less, of the monomer unit (A2). Within this range, the SP value (SP(A)) of crystalline vinyl resins can be more readily controlled to the above range, and the release property, the durability, and the charge rising performance are likely to be good.

The crystalline vinyl resin comprises preferably 55.0 to 80.0% by mass, more preferably from 60.0 to 70.0% by mass, of the monomer unit (A2).

Examples of methods for introducing the monomer unit represented by formula (A2) may include a method of polymerizing the following (meth)acrylic esters. Examples of such (meth)acrylic esters may include stearyl (meth)acrylate, nonadecyl (meth)acrylate, eicosyl (meth)acrylate, heneicosanyl (meth)acrylate, behenyl (meth)acrylate, lignoceryl (meth)acrylate, ceryl (meth)acrylate, octacosyl (meth)acrylate, myricyl (meth)acrylate, dotriacontanyl (meth)acrylate, 2-decyltetradecyl (meth)acrylate, and the like.

The crystalline vinyl resin may comprise only one type or two or more types of the monomer units represented by formula (A2) described above.

The content proportion of the monomer unit (A2) in the binder resin is preferably 5.0% by mass or more, more preferably 10.0% by mass or more, and still more preferably 15.0% by mass or more. Within this range, the amount of the crystalline resin in the toner particle is moderate, and both the low-temperature fixability and the durability are easily achieved.

The content proportion of the monomer unit (A2) in the binder resin is preferably 30.0% by mass or less, more preferably 25.0% by mass or less, and still more preferably 20.0% by mass or less. Within this range, the amount of the crystalline resin in the toner particle is moderate, and both the low-temperature fixability and the durability are easily achieved.

The content proportion of the monomer unit (A2) in the binder resin is preferably 5.0 to 30.0% by mass, more preferably 10.0 to 25.0% by mass, and still more preferably 15.0 to 20.0% by mass.

The crystalline vinyl resin preferably comprises a monomer unit corresponding to N-vinyl-2-pyrrolidone. A crystalline vinyl resin comprising the monomer unit corresponding to N-vinyl-2-pyrrolidone tends to enhance the phase separation property with release agents, thereby further improving release property.

The crystalline vinyl resin comprises preferably 5.0 to 20.0% by mass, more preferably from 10.0 to 20.0% by mass, of the monomer unit corresponding to N-vinyl-2-pyrrolidone. The content of the monomer unit corresponding to N-vinyl-2-pyrrolidone in the crystalline vinyl resin within the range mentioned above tends to enhance the phase separation property with release agents and facilitates the improvement of the release property.

When an SP value of the amorphous polyester resin is taken as SP(B) [(J/cm³)^{0.5}], the SP(A) of the crystalline vinyl resin described above and the SP(B) preferably satisfy expression (2) below.

$$- 1. < [ S P ( B ) - S P ( A ) ] < 1.5 \qquad ( 2 )$$

[SP(B)−SP(A)] indicates the difference between the SP values of the amorphous polyester resin and the crystalline vinyl resin. The larger the value, the higher the hydrophilicity of the amorphous polyester resin. In particular, when the toner is produced in an aqueous medium, it is easier to allow the highly hydrophilic amorphous polyester resin to exist in the toner surface layer side during the production process of the toner.

The value of [SP(B)−SP(A)] is preferably greater than −1.0, more preferably greater than −0.5, and still more preferably greater than 0.0. A value of [SP(B)−SP(A)] within this range makes it possible to allow a large amount of the highly hydrophilic amorphous polyester resin to exist on the toner surface layer side and reduce the amount of the crystalline vinyl resin of the outermost layer of the toner. As a result, the durability and the charge rising performance are likely to be better.

The value of [SP(B)−SP(A)] is preferably less than 1.5, more preferably less than 1.2, and further preferably less than 1.0. A value of [SP(B)−SP(A)] within this range increases the affinity between the amorphous polyester resin and the crystalline vinyl resin, making it easier to exist the polar segments in the crystalline vinyl resin uniformly in the whole toner particle. As a result, the release property, the durability, and the charge rising performance in a high temperature and high humidity environment are likely to be better.

The SP value (SP(B) [(J/cm³)^{0.5}]) of the amorphous polyester resin is preferably from 20.0 to 23.0, and more preferably from 21.0 to 22.5. An SP value of the amorphous polyester resin within this range makes it easier to satisfy expression (2) and to exhibit better releasing properties, durability, and charge rising performance in a high temperature and high humidity environment.

The SP(B) [(J/cm³)^{0.5}] can be controlled by the proportion of a highly hydrophobic acid monomer in the amorphous polyester resin. The SP(B) becomes small when the proportion of the highly hydrophobic acid monomer in the amorphous polyester resin is high, and becomes large when the proportion is low. For example, the SP(B) can be controlled in the above range by setting the proportion of acid monomers, such as a dodecenylsuccinic acid monomer, in the amorphous polyester resin to 5 to 40 mol %.

The crystalline vinyl resin preferably comprises a monomer unit (B) represented by formula (B) below.

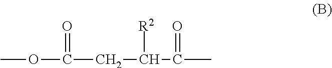

In formula (B), R² represents a C8-16 alkyl or alkenyl group. R² preferably has a carbon number of 10 to 14, and more preferably has a carbon number of 12.

For example, an amorphous polyester resin comprising the monomer unit (B) can be obtained by condensation polymerization of an alcohol monomer and an acid monomer, such as dodecenylsuccinic acid, dodecylsuccinic acid, and an anhydride thereof. When dodecenylsuccinic acid is used as the acid monomer, an amorphous polyester resin comprising a monomer unit (B) in which R² has a carbon number of 12 can be obtained.

An amorphous polyester resin comprising the above monomer unit (B) enables the formation of hydrophobic segments through gathering of the alkyl or alkenyl groups in the side chain. For this reason, the affinity between the hydrophobic segments of the crystalline vinyl resin in the toner particle and the amorphous polyester resin becomes high. This makes it easy for the hydrophobic segments of the crystalline vinyl resin to exist more stably in the vicinity of the surface layer of the toner, and for the polar segments of the crystalline vinyl resin to exist uniformly in the entire toner particle. As a result, the release property, the durability, and the charge rising performance are likely to be better in a high temperature and high humidity environment.

The amorphous polyester resin preferably comprises 5.0% by mass or more, more preferably 10.0% by mass or more, still more preferably 15.0% by mass or more, further preferably 20.0% by mass or more, of the monomer unit (B). Within this range, the affinity with the crystalline vinyl resin becomes higher, and the release property, the durability, and the charge rising performance are more likely to be better.

The amorphous polyester resin preferably comprises 45.0% by mass or less, more preferably 40.0% by mass or less, still more preferably 35.0% by mass or less, further preferably 30.0% by mass or less, of the monomer unit (B).

The content of the monomer unit (B) in the amorphous polyester resin within this range can enhance the coverage properties of the toner particle with the amorphous polyester resin and make it easier to improve the durability and the charge rising performance. In addition, the glass transition temperature of the amorphous polyester resin can be increased, and the heat resistance of the toner is likely to be better.

The amorphous polyester resin preferably comprises 5.0 to 45.0% by mass, more preferably 10.0 to 40.0% by mass, still more preferably 15.0 to 35.0% by mass, further preferably 20.0 to 30.0% by mass, of the monomer unit (B).

In addition, the content proportion of the monomer units (B) in the binder resin is preferably 0.5% by mass or more, more preferably 0.7% by mass or more, and more preferably 1.0% by mass or more. The content proportion within this range makes it easier to control the value of A(max)/A (min) to be within the range mentioned above and to allow the polar segments of the crystalline vinyl resin to exist uniformly in the whole toner particle. Therefore, the release property, the durability, and the charge rising performance are likely to be better.

In addition, the content proportion of the monomer units (B) in the binder resin is preferably 4.0% by mass or less, more preferably 3.0% by mass or less, and still more preferably 2.0% by mass or less. The content proportion within this range makes it easier to control the value of A(max)/A (min) to be within the range mentioned above, and to allow the polar segments of the crystalline vinyl resin to exist uniformly in the whole toner particle. Therefore, the release property, the durability, and the charge rising performance are likely to be good.

The content proportion of the monomer unit (B) in the binder resin is preferably 0.5 to 4.0% by mass, more preferably 0.7 to 3.0% by mass, and still more preferably 1.0 to 2.0% by mass.

It is preferred that the crystalline vinyl resin in the binder resin comprises the monomer unit (A2), and the amorphous polyester resin comprises the monomer unit (B). In addition, the content proportion of the monomer unit (A2) in the binder resin is preferably 5.0 to 30.0% by mass, and the content proportion of the monomer unit (B) in the binder resin is preferably 0.5 to 4.0% by mass.

As described above, a content proportion of the monomer unit (A2) in the binder resin within the above range facilitates the achievement of both the low-temperature fixability and the durability, and a content proportion of the monomer unit (B) within the above range facilitates the achievement of all of the release property, the durability, and the charge rising performance. That is, the constitution described above makes it possible to highly achieve all of excellent low-temperature fixability, excellent release property, durability, and charge rising performance.

Also, it is preferred that the amorphous polyester resin comprises a monomer unit corresponding to trimellitic acid or trimellitic anhydride. This allows the polarity of the amorphous polyester resin to be partially increased, making it easier for the amorphous polyester resin to exist on the surface layer side of the toner particle and reducing the crystalline vinyl resin in the outermost layer of the toner. As a result, the durability and the charge rising performance are likely to be better.

The acid value of the amorphous polyester resin is preferably 3.0 mgKOH/g or more, more preferably 4.5 mgKOH/g or more, and still more preferably 5.0 mgKOH/g or more. The acid value of is preferably 20.0 mgKOH/g or less, more preferably 15.0 mgKOH/g or less, and still more preferably 10.0 mgKOH/g or less.

That is, the acid value of the amorphous polyester resin is preferably from 3.0 to 20.0 mgKOH/g, more preferably from 4.5 to 15.0 mgKOH/g, and still more preferably from 5.0 to 10.0 mgKOH/g. An acid value within this range makes it easier to control the thickness of the amorphous polyester resin of the surface layer of the toner particle and achieve both the low-temperature fixability and the durability.

The weight-average molecular weight of the amorphous polyester resin is preferably 8000 or more, more preferably 10000 or more, and still more preferably 12000 or more. Being within this range allows the strength of the surface layer of the toner particle to be increased, making it easier to improve durability. In addition, the glass transition temperature of the amorphous polyester resin can be raised, and the heat resistance of the toner is likely to be good.

The weight-average molecular weight of the amorphous polyester resin is preferably 25000 or less, more preferably 21000 or less, and still more preferably 18000 or less. Being within this range can make the surface hardness of the toner particle good and facilitate the improvement of low-temperature fixability.

The weight-average molecular weight of the amorphous polyester resin is preferably from 8000 to 25000, more preferably from 10000 to 21000, and still more preferably from 12000 to 18000.

The binder resin preferably comprises 1.5% by mass or more, more preferably 3.5% by mass or more, still more preferably 4.0% by mass or more, and further preferably 4.5% by mass or more of the amorphous polyester resin. The binder resin comprises preferably 10.0% by mass or less, more preferably 9.0% by mass or less, still more preferably 8.0% by mass or less, of the polyester resin.

The binder resin comprises preferably 3.5 to 10.0% by mass, more preferably 4.0 to 9.0% by mass, still more preferably 4.5 to 8.0% by mass, of the amorphous polyester resin. Within this range, the thickness of the amorphous polyester resin on the surface layer of the toner particle can be good, and the achievement of both the low-temperature fixability and the durability is facilitated.

The binder resin comprises preferably 9.5 to 50.0% by mass, more preferably 15.0 to 45.0% by mass, still more preferably 20.0 to 30.0% by mass, of the crystalline vinyl resin.

A binder resin comprising 9.5% by mass or more of the crystalline vinyl resin facilitates an increase in the low-temperature fixability due to the improved sharp melt property. Also, a binder resin comprising 50.0% by mass or less of the crystalline vinyl resin facilitates the achievement of all of the durability, charge rising performance, and release property.

When a mass proportion of the crystalline vinyl resin in the binder resin is taken as WA (% by mass) and a mass proportion of the amorphous polyester resin in the binder resin is taken as WB (% by mass), it is preferable that the WA and the WB satisfy expression (3) below.

$$3. 0 < ( W A / W B ) < 20. \qquad ( 3 )$$

The value of WA/WB is preferably greater than 3.0, more preferably greater than 4.0, and still more preferably greater than 5.0. The value of WA/WB is preferably less than 20.0, more preferably less than 15.0, and still more preferably less than 10.0. Within this range, the distribution of the polar segments of the crystalline vinyl resin in the toner particle can easily be made uniform, and the release property, the durability, and the charge rising performance are likely to be good.

It is preferable that the binder resin comprises an amorphous styrenic vinyl resin as the amorphous resin other than the amorphous polyester resin. That is, it is preferred that the amorphous resin further include a styrenic vinyl resin.

When the mass proportion of the styrenic vinyl resin in the binder resin is taken as WC (% by mass), the WC is preferably 45.0% by mass or more, more preferably 50.0% by mass or more, and still more preferably 55.0% by mass or more. Within this range, the durability and charge rising performance are likely to be better.

WC is preferably 90.0% by mass or less, more preferably 85.0% by mass or less, and still more preferably 80.0% by mass or less. Within this range, the low-temperature fixability is likely to be better.

That is, the binder resin comprises preferably 45.0 to 90.0% by mass, preferably 45.0 to 85.0% by mass, more preferably 50.0 to 85.0% by mass, still more preferably 55.0 to 80.0% by mass, of a styrenic vinyl resin.

After the toner particle is stained with ruthenium, the cross-section of the toner particle is observed using a transmission electron microscope (TEM). In this cross-section, when a peripheral length of a toner particle is taken as C2, and a length of a portion where the amorphous resin (amorphous polyester resin) is observed among the peripheral length of the toner particle is taken as C1, it is preferred that the C1 and the C2 satisfy expression (5) below.

$$( C 1 / C 2 ) \times 100 \geq 80. \qquad ( 5 )$$

The amorphous resin in the toner particle is strongly stained by staining the toner with ruthenium. As a result, portions comprising an amorphous resin as a main component are observed as stained portions, while portions comprising a crystalline vinyl resin as a main component are observed as unstained portions. That is, when the toner has a core-shell structure composed of a core comprising a crystalline vinyl resin as the main component and a shell comprising an amorphous resin as the main component, where the shell covers the core, only the shell portions are stained and observed.

As mentioned above, portions where the amorphous resin is observed are portions stained with ruthenium. That is, the C1 is the length of a portion stained with ruthenium among the peripheral length C2 of the toner particle. The larger the value of (C1/C2)×100, the larger the degree of coverage of the surface of the toner particle with amorphous polyester resin.

The value of [(C1/C2)×100] is preferably from 60.0 to 100.0, more preferably from 70.0 to 99.0, and still more preferably from 80.0 to 95.0. Within this range, the toner particle is sufficiently covered with the amorphous polyester resin, and the amount of the crystalline vinyl resin in the outermost layer of the toner can be reduced. As a result, the durability is likely to be better.

The degree of coverage with the amorphous polyester resin can be controlled, for example, by the structure and amount of the amorphous polyester resin or by a method of producing the toner. For example, the degree of coverage of a toner particle with the amorphous polyester resin can be increased by using a highly hydrophilic amorphous polyester resin and producing a toner by a suspension polymerization method.

In a chart with an x-axis representing time and a y-axis representing the ion amounts corresponding to the monomer unit (A), obtained by the TOF-SIMS described above, the time on the X-axis at which A (min) is detected is converted to a thickness of the PMMA standard sample film sputtered, and the obtained value is taken as d (min).

Here, d (min) represents the thickness of the PMMA standard sample film sputtered within a time period from the start of measurement to the time at which A (min) is detected. That is, d (min) corresponds to the distance from the surface of the toner particle to the region where the amount of the crystalline vinyl resin is the smallest among regions from the toner particle surface to 20 nm toward the inside of the particle. In other words, d (min) represents the distance from the surface of the toner particle to the region where the amount of the amorphous polyester is the largest among regions from the toner particle surface to 20 nm toward the inside of the particle, and can be regarded as the thickness of the amorphous polyester resin that covers the toner particle surface.

The value of d (min) is preferably 5 nm or more and less than 20 nm, and more preferably 10 nm or more and less than 20 nm. A d (min) within this range ensures sufficient coverage of the surface of the toner particle with an amorphous polyester resin, enhancing the strength of the surface layer, and also does not impede heat conduction into the interior of the toner particle, making the durability and the low-temperature fixability likely to be better.

The d (min) can be controlled by the structure, acid value, and amount of the amorphous polyester resin. The larger the amount of the amorphous polyester resin, the larger the value of d (min), and the smaller the amount of the amorphous polyester resin, the smaller the value of d (min). For example, by controlling the amount of the amorphous polyester resin in the toner particle within the range described above, the value of d (min) can be controlled within the above-described range.

The toner particle preferably comprises an ester wax as a release agent.

When an SP value of the ester wax is taken as SP(D) [(J/cm³)^{0.5}], the value of SP(D) is preferably from 17.0 to 19.0.

SP(D) is more preferably 17.5 or more, and still more preferably 18.0 or more. The upper limit of SP(D) is not particularly limited as long as the release agent is an ester wax, but SP(D) is preferably 19.0 or less, for example. SP(D) is more preferably from 17.5 to 19.0, and still more preferably from 18.0 to 19.0.

SP(D) within the above range makes the phase separation property good, and makes the release property likely to be better.

### Components of Toner

Each of the components constituting the toner and a method for producing the toner will be described in more detail.

### Binder Resin

The toner particle comprises a binder resin. The binder resin comprises the crystalline vinyl resin and the amorphous vinyl resin, as described above.

The crystalline vinyl resin preferably comprises the monomer unit (A) represented by formula (A). Examples of methods for introducing the monomer unit (A) into the crystalline vinyl resin may include a method of polymerizing a (meth)acrylic acid ester, acrylonitrile, methacrylonitrile, or the like. These may be used alone or in combination of two or more types thereof.

The crystalline vinyl resin preferably comprises the monomer unit (A2) represented by formula (A2). Examples of methods for introducing the monomer unit (A2) into the crystalline vinyl resin may include a method of polymerizing the following (meth)acrylic acid esters.

Examples thereof may include stearyl (meth)acrylate, nonadecyl (meth)acrylate, eicosyl (meth)acrylate, heneicosanyl (meth)acrylate, behenyl (meth)acrylate, lignoceryl (meth)acrylate, ceryl (meth)acrylate, octacosyl (meth)acrylate, myricyl (meth)acrylate, dotriacontanyl (meth)acrylate, 2-decyltetradecyl (meth)acrylate, and the like. These may be used alone or in combination of two or more types thereof.

The crystalline vinyl resin may further comprise other monomer units, in addition to the monomer unit (A) and the monomer unit (A2).

Examples of methods for introducing other monomer units into a crystalline vinyl resin may include a method of polymerizing a (meth)acrylic acid ester and another vinylic monomer.

Examples of other vinyl monomers include the following:

(Meth)acrylic acid esters such as styrene, α-methylstyrene, methyl (meth)acrylate, ethyl (meth)acrylate, n-butyl (meth)acrylate, t-butyl (meth)acrylate, and 2-ethylhexyl (meth)acrylate, and the like.

Monomers having a urea group: for example, monomers obtained by reacting an amine having 3 to 22 carbon atoms [primary amines (n-butylamine, t-butylamine, propylamine, isopropylamine, and so forth), secondary amines (di-n-ethylamine, di-n-propylamine, di-n-butylamine, and so forth), aniline, cycloxylamine, and so forth] with an isocyanate having 2 to 30 carbon atoms and an ethylenically unsaturated bond by a known method, and the like.

Monomers having a carboxy group; for example, methacrylic acid, acrylic acid, and 2-carboxyethyl (meth)acrylate, and the like.

Monomers having a hydroxy group; for example, 2-hydroxyethyl (meth)acrylate, 2-hydroxypropyl (meth)acrylate, and the like.

Monomers having an amide group; for example, acrylamide, and monomers obtained by reacting an amine having 1 to 30 carbon atoms with a carboxylic acid having 2 to 30 carbon atoms and having an ethylenically unsaturated bond (acrylic acid, methacrylic acid, and so forth) by a known method, and the like.

Monomers having a lactam structure; N-vinyl-2-pyrrolidone, and the like.

The crystalline resin can be synthesized by copolymerizing a (meth)acrylic ester for introducing the monomer unit (A2) and another vinylic monomer to synthesize a crystalline vinyl resin and further reacting yet another vinylic monomer in accordance with a hydrogen abstraction reaction.

The hydrogen abstraction reaction is a reaction in which a hydrogen atom bound to a carbon atom is drawn to generate a radical, and other vinylic monomers can be further reacted from the generated radical. This reaction enables the monomer unit (A2) in the crystalline vinyl resin to form a more aggregated state within the molecule, making it easier to enhance crystallinity.

The amorphous resin comprises an amorphous polyester resin. The amorphous polyester resin is obtained, for example, by selecting and then combining suitable compounds from among polycarboxylic acids, polyols, hydroxycarboxylic acids, and the like, and synthesizing the compounds using a conventionally known method such as a transesterification method or a polycondensation method, for example.

The polycarboxylic acid is a compound comprising two or more carboxyl groups in one molecule. Among them, the dicarboxylic acid is a compound comprising two carboxyl groups in one molecule, and is preferably used.

Examples of polycarboxylic acid may include dicarboxylic acids, such as dodecenylsuccinic acid, dodecylsuccinic acid, oxalic acid, succinic acid, glutaric acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-carboxylic acid, hexahydroterephthalic acid, malonic acid, pimelic acid, suberic acid, phthalic acid, terephthalic acid, isophthalic acid, tetrachlorophthalic acid, chlorophthalic acid, nitrophthalic acid, p-phenylenediacetic acid, m-phenylenediacetic acid, o-phenylenediacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracene dicarboxylic acid, and cyclohexane dicarboxylic acid.

Among the above, dodecenylsuccinic acid, terephthalic acid, and isophthalic acid are preferably used. These may be used alone as a single type or in combination with two or more types thereof. Combinations of two or more polycarboxylic acids are not particularly limited, but it is preferable, for example, to use isophthalic acid in combination with dodecenylsuccinic acid or sebacic acid.

Examples of the polyvalent carboxylic acid other than the dicarboxylic acid include trimellitic acid, trimesic acid, pyromellitic acid, naphthalenetricarboxylic acid, naphthalenetetracarboxylic acid, pyrenetricarboxylic acid, pyrenetetracarboxylic acid, itaconic acid, glutaconic acid and the like. Among others, trimellitic acid is preferable. These may be used alone as a single type or in combination with two or more types thereof.

A polyol is a compound comprising two or more hydroxyl groups in one molecule. Of these, a diol, which is a compound containing two hydroxyl groups in one molecule, is preferably used.

For example, specific examples include ethylene glycol, diethylene glycol, triethylene glycol, 1,2-propylene glycol, 1,3-propylene glycol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanedecanediol, diethylene glycol, triethylene glycol, dipropylene glycol, polyethylene glycol, polypropylene glycol, polytetramethylene ether glycol, 1,4-cyclohexanediol, 1,4-cyclohexanedimethanol, 1,4-butenediol, neopentyl glycol, 1,4-cyclohexanediol, polytetramethylene glycol, hydrogenated bisphenol A, bisphenol A, bisphenol F, bisphenol S, alkylene oxide (ethylene oxide, propylene oxide, butylene oxide, and the like) adducts of the above bisphenols, and the like. These may be used alone as a single type or in combination with two or more types thereof.

Among the diols described above, C2-12 alkylene glycols and alkylene oxide adducts of bisphenols are preferable. Alkylene oxide adducts of bisphenols and combinations thereof with C2-12 alkylene glycols are particularly preferred. For example, it is preferred to use bisphenol A-propylene oxide or bisphenol A-ethylene oxide in combination with ethylene glycol.

Examples of trivalent or higher polyols include glycerin, trimethylolethane, trimethylolpropane, pentaerythritol, hexamethylolmelamine, hexaethylolmelamine, tetramethylolbenzoguanamine, tetraethylolbenzoguanamine, sorbitol, trisphenol PA, phenol novolac, cresol novolak, alkylene oxide adducts of the above trivalent or higher polyphenols, and the like. These may be used alone or in combination of two or more.

The amorphous resin preferably comprises a styrenic vinyl resin. By comprising styrenic vinyl resin, the composition of the toner particle becomes similar to the crystalline vinyl resin, which makes it easier to achieve better durability.

Examples of styrene-acrylic resins may include homopolymers of the following polymerizable monomers, copolymers of a combination of two or more types thereof, or mixtures thereof.

Styrene-based monomers such as styrene, α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene;
(meth)acrylic monomers such as methyl (meth)acrylate, ethyl (meth)acrylate, n-propyl (meth)acrylate, iso-propyl (meth)acrylate, n-butyl (meth)acrylate, iso-butyl (meth)acrylate, tert-butyl (meth)acrylate, n-amyl (meth)acrylate, n-hexyl (meth)acrylate, 2-ethylhexyl (meth)acrylate, n-octyl (meth)acrylate, n-nonyl (meth)acrylate, cyclohexyl (meth)acrylate, benzyl (meth)acrylate, dimethyl phosphate ethyl (meth)acrylate, diethyl phosphate ethyl (meth)acrylate, dibutyl phosphate ethyl (meth)acrylate and 2-benzoyloxyethyl (meth)acrylate, (meth)acrylonitrile, 2-hydroxyethyl (meth)acrylate, (meth)acrylic acid, and maleic acid;
vinyl ether monomers such as vinyl methyl ether and vinyl isobutyl ether;
vinyl ketone monomers such as vinyl methyl ketone, vinyl ethyl ketone, vinyl isopropenyl ketone, and the like; and
polyolefins such as ethylene, propylene, butadiene, and the like.

A polyfunctional polymerizable monomer can be used, if necessary, for the styrene acrylic resin. Examples of the polyfunctional polymerizable monomer include diethylene glycol di(meth)acrylate, triethylene glycol di(meth)acrylate, tetraethylene glycol di(meth)acrylate, polyethylene glycol di(meth)acrylate, 1,6-hexanediol di(meth)acrylate, neopentyl glycol di(meth)acrylate, tripropylene glycol di(meth)acrylate, polypropylene glycol di(meth)acrylate, 2,2′-bis(4-((meth)acryloxydiethoxy)phenyl)propane, trimethylolpropane tri(meth)acrylate, tetramethylolmethane tetra(meth)acrylate, divinylbenzene, divinylnaphthalene, divinyl ether, and the like.

In addition, it is also possible to further add known chain transfer agents and polymerization inhibitors to control the degree of polymerization. Examples of polymerization initiators may include organic peroxide-based initiators and azo-based polymerization initiators.

Examples of the organic peroxide-based initiator include benzoyl peroxide, lauroyl peroxide, di-α-cumyl peroxide, 2,5-dimethyl-2,5-bis(benzoylperoxy)hexane, bis (4-t-butylcyclohexyl)peroxydicarbonate, 1,1-bis(t-butylperoxy)cyclododecane, t-butylperoxymaleic acid, bis(t-butylperoxy)isophthalate, methyl ethyl ketone peroxide, tert-butylperoxy-2-ethylhexanoate, diisopropylperoxycarbonate, cumene hydroperoxide, 2,4-dichlorobenzoyl peroxide, tert-butyl-peroxypivalate, t-butyl peroxy isobutyrate, t-butyl peroxy neodecanoate, and the like.

Examples of the azo-based polymerization initiator include 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, azobismethylbutyronitrile, 2,2′-azobis-(methyl isobutyrate), and the like.

Further, as the polymerization initiator, a redox-based initiator in which an oxidizing substance and a reducing substance are combined can also be used.

Examples of the oxidizing substance include hydrogen peroxide, an inorganic peroxide of a persulfate (sodium salt, potassium salt and ammonium salt), and an oxidizing metal salt of a tetravalent cerium salt.

Examples of the reducing substance include reducing metal salts (divalent iron salt, monovalent copper salt and trivalent chromium salt), ammonia, lower amines (amines having from 1 to 6 carbon atoms such as methylamine and ethylamine), amine compounds such as hydroxylamine, reducing sulfur compounds such as sodium thiosulfate, sodium hydrosulfite, sodium hydrogen sulfite, sodium sulfite, sodium formaldehyde sulfoxylate, lower alcohols (having 1 to 6 carbon atoms), ascorbic acid or salts thereof and lower aldehydes (having 1 to 6 carbon atoms).

The polymerization initiator is selected with reference to a 10-h half-life temperature, and is used alone or in combination. The amount of the polymerization initiator added varies depending on the desired degree of polymerization but is generally from 0.5 to 20.0 parts by mass with respect to 100.0 parts by mass of the polymerizable monomers.

Other binder resins are not particularly limited, and examples thereof include a styrene acrylic resin, an epoxy resin, a polyester resin, a polyurethane resin, a polyamide resin, a cellulose resin, a polyether resin, a mixed resin or a composite resin thereof, and the like. A styrene acrylic resin or a polyester resin is preferable from the viewpoint of being inexpensive, easily available, and excellent in low-temperature fixability.

### Wax

The toner particle preferably comprises a release agent. The release agent can be selected from the group consisting of a hydrocarbon wax and an ester wax.

When a hydrocarbon wax and/or an ester wax is used, it is easier to secure an effective release property. The toner preferably comprises an ester wax as a release agent.

Hydrocarbon waxes are not particularly limited, and examples thereof may include the following:

Aliphatic hydrocarbon waxes; and low-molecular-weight polyethylene, low-molecular-weight polypropylene, low-molecular-weight olefin copolymers, Fischer-Tropsch wax, or waxes obtained by oxidizing or adding acids to these waxes.

The ester wax may be any wax having at least one ester bond in one molecule, and either a natural ester wax or a synthetic ester wax may also be used.

Ester waxes are not particularly limited, and examples thereof may include the following:
Esters of monohydric alcohols and monocarboxylic acids such as behenyl behenate, stearyl stearate, and palmityl palmitate;
Esters of divalent carboxylic acids and monoalcohols such as dibehenyl sebacate;
Esters of divalent alcohols and monocarboxylic acids such as ethylene glycol distearate and hexanediol dibehenate;
Esters of trihydric alcohols and monocarboxylic acids such as glycerin tribehenate;
Esters of tetrahydric alcohols and monocarboxylic acids such as pentaerythritol tetrastearate, and pentaerythritol tetrapalmitate;
Esters of hexahydric alcohols and monocarboxylic acids such as dipentaerythritol hexastearate, dipentaerythritol hexapalmitate, and dipentaerythritol hexabehenate;
Esters of polyfunctional alcohols and monocarboxylic acids such as polyglycerin behenate; and natural ester waxes such as carnauba wax and rice wax, and the like.

Among them, esters of hexahydric alcohols and monocarboxylic acids, such as dipentaerythritol hexastearate, dipentaerythritol hexapalmitate, and dipentaerythritol hexabehenate, are preferred.

As the releasing agent, a hydrocarbon wax or an ester wax may be used alone, a hydrocarbon wax and an ester wax may be used in combination, and two or more types may be used in combination. It is preferred to use an ester wax alone, or alternatively, to use two or more types of these.

The content of the release agent in the toner particle is preferably 3.0 to 20.0% by mass, and more preferably 5.0 to 15.0% by mass. The content of the release agent in the toner particle being within the above range makes it easier to secure the release property during fixing.

The melting point of the release agent is preferably 60 to 120° C. and more preferably 70 to 100° C. A melting point of the release agent within this range allows the release agent to melt during fixing, making it easier for the release agent to outmigrate on the surface of the toner particle and thereby facilitating the exhibition of release property.

### Colorant

The toner particle may include a colorant. Known pigments and dyes can be used as the colorant. Pigments are preferable as the colorant from the viewpoint of excellent weather resistance.

Examples of cyan-based colorants include copper phthalocyanine compounds and derivatives thereof, anthraquinone compounds, basic dye lake compounds, and the like.

For example, specifical examples include C. I. Pigment Blue 1, 7, 15, 15:1, 15:2, 15:3, 15:4, 60, 62, 66, and the like.

Examples of magenta colorants include condensed azo compounds, diketopyrrolopyrrole compounds, anthraquinone compounds, quinacridone compounds, basic dye lake compounds, naphthol compounds, benzimidazolone compounds, thioindigo compounds, perylene compounds, and the like.

For example, specifical examples include C. I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, 254, and C. I. Pigment Violet 19, and the like.

Examples of yellow colorants include condensed azo compounds, isoindolinone compounds, anthraquinone compounds, azo metal complexes, methine compounds, and allylamide compounds.

For example, specific examples include C. I. Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191, 194, and the like.

Examples of black colorants include those colored black using the above-mentioned yellow colorant, magenta colorant and cyan colorant, and carbon black.

These colorants can be used alone or as a mixture, and they can be used in the form of a solid solution.

The colorant content is not particularly limited, but the colorant is preferably used in an amount from 1.0 to 20.0 parts by mass with respect to 100.0 parts by mass of a binder resin.

### Crosslinking Agent

For controlling the molecular weight of the binder resin, a crosslinking agent may be added upon producing the toner particle.

Examples of crosslinking agents may include 1,6-hexanediol diacrylate, divinylbenzene, and the like. The amount of the crosslinking agent added is not particularly limited, and preferably, for example, from 0.001 to 15.000 parts by mass relative to 100 parts of polymerizable monomers.

### External Additive

The toner may comprise an external additive as needed. This makes it possible to control, for example, flowability, charging performance, and cleaning performance.

Examples of the external additives may include inorganic oxide fine particles, such as silica fine particles, alumina fine particles, and titanium oxide fine particles, inorganic stearic acid compound fine particles, such as aluminum stearate fine particles and zinc stearate fine particles, or inorganic titanate compound fine particles, such as strontium titanate and zinc titanate. The external additive may be used alone as a single type or in combination with two or more types thereof.

A silica fine particle is preferably used as an external additive. A silica fine particle having a hydrophobically treated surface is preferably used. For example, a silica fine particle hydrophobically treated with hexamethyldisilazane can be used.

The total amount of external additives added is preferably from 0.05 to 10.00 parts by mass and more preferably from 0.1 to 5.0 parts by mass relative to 100 parts by mass of the toner particle.

### Production Method of Toner Particle

The toner particle may be produced by any conventionally known method, such as a suspension polymerization method, an emulsion aggregation method, a dissolution suspension method, or a pulverization method, as long as it is within the scope of the constitution of the present disclosure. The toner particle is preferably produced by a suspension polymerization method.

The details of the manufacturing method for a toner particle using the suspension polymerization method are described below.

For example, a crystalline vinyl resin and an amorphous polyester resin that have been synthesized in advance are added to a mixture of polymerizable monomers for producing an amorphous vinyl resin. As necessary, other materials such as a colorant, a release agent, a crosslinking agent, and a charge control agent are added, uniformly dissolved, or dispersed to prepare a polymerizable monomer composition.

For example, a polymerizable monomer composition is prepared by mixing a polymerizable monomer that produces an amorphous vinyl resin, a colorant, and optional other additives in an aqueous medium, and adding thereto a crystalline vinyl resin, an amorphous polyester resin, an optional wax, and the like.

Then, the polymerizable monomer composition is dispersed in an aqueous medium using a stirrer or the like to prepare a suspended particle of the polymerizable monomer composition. Then, the polymerizable monomers contained in the particle are polymerized with an initiator or the like to prepare a toner particle.

After the polymerization is completed, the toner particle is filtered, washed, and dried by known methods, and as necessary, an external additive may be added to prepare a toner.

As the polymerization initiator, the known polymerization initiator mentioned above may be used.

In addition, known chain transfer agents and polymerization inhibitors may also be used.

The aqueous medium may contain an inorganic or organic dispersion stabilizer.

As the dispersion stabilizer, known dispersion stabilizers can be used.

Examples of inorganic dispersion stabilizers include phosphates such as hydroxyapatite, tricalcium phosphate, dicalcium phosphate, magnesium phosphate, aluminum phosphate, and zinc phosphate; carbonates such as calcium carbonate and magnesium carbonate; metal hydroxides such as calcium hydroxide, magnesium hydroxide, and aluminum hydroxide; sulfates such as calcium sulfate and barium sulfate; calcium metasilicate; bentonite; silica; and alumina, and the like.

On the other hand, examples of organic dispersion stabilizers include polyvinyl alcohol, gelatin, methyl cellulose, hydroxypropyl methylcellulose, ethyl cellulose, sodium salts of carboxymethylcellulose, polyacrylic acid and its salts, and starch, and the like.

When an inorganic compound is used as a dispersion stabilizer, a commercially available product may be used without change, but in order to obtain finer particles, the above inorganic compound that is produced in an aqueous medium may also be used.

For example, in the case of calcium phosphate such as hydroxyapatite or tricalcium phosphate, a phosphate aqueous solution and a calcium salt aqueous solution may be mixed under high-speed stirring.

The aqueous medium may comprise a surfactant. As the surfactant, known surfactants can be used. Examples thereof may include anionic surfactants such as sodium dodecylbenzenesulfate and sodium oleate; cationic surfactants; amphoteric surfactants; and nonionic surfactants.

The number-average particle diameter of the toner is, for example, preferably 4.0 to 9.0 μm, more preferably 4.5 to 8.5 μm, and still more preferably 5.0 to 8.0 μm.

A toner particle having a core-shell structure may be produced by subjecting the core particle to a shell layer formation step in an aqueous medium after a core particle formation step by the pulverization method.

### Core Particle Formation Step

In the core particle formation step, the core particle is formed by a melt-kneading and pulverization method. For example, a crystalline vinyl resin and an amorphous polyester resin that have been synthesized in advance are mixed with an optional release agent, an optional colorant, and the like, and the mixture is then melt-kneaded. The obtained melt-kneaded product is cooled and then pulverized, and optionally subjected to processing, such as classification, to form a core particle containing a crystalline vinyl resin and an amorphous vinyl resin. Here, for melt-kneading and pulverization, known apparatuses can be used.

### Shell Layer Formation Step

The core particle formed is dispersed in an aqueous medium comprising ion exchange water and a dispersing agent to prepare a core particle dispersion.

Further, an aqueous dispersion of an amorphous polyester resin is prepared by dispersing an amorphous polyester resin in another aqueous medium. The solid content concentration of the aqueous dispersion is not particularly limited and is preferably, for example, 30.0 to 70.0% by mass.

An aqueous dispersion of an amorphous polyester resin is added to the core particle dispersion. In this case, the amorphous polyester resin is preferably added such that the amount of the amorphous polyester resin added relative to 100 parts by mass of the core particle be 3 to 20 parts by mass and more preferably 5 to 10 parts by mass.

Thereafter, by raising the temperature and maintaining the temperature, a shell layer comprising amorphous polyester resin is formed on the surface of the core particle. After cooling to room temperature, post-treatments, such as filtration, washing, and drying, are carried out to prepare a toner particle having a core-shell structure.

### Producing Method of Toner

In the external addition process, an external additive, such as a silica fine particle, is externally added to the toner particle obtained.

As the external addition conditions, a fixed state of the external additive and the coverage state of the toner particle with the external additive can be controlled as desired by the rotation speed rpm of a stirring spring provided in an external addition machine and the external addition time.

It is effective to increase the rotation speed of the stirring spring and prolong the external addition time in order to more firmly fix the external additive by the toner particle, and in particular, the fixing strength of the external additive can be further increased by increasing the rotation speed. In addition, since the external additive particle with a small particle diameter tends to form aggregates, it is preferred to cover the toner particle with the external additive while being subjected to a deagglomeration treatment by controlling the external addition conditions. In order to further advance the deagglomeration while maintaining high fixing strength, it is effective to suppress the rotation speed and prolong the external addition time.

The conditions for the external addition are not particularly limited, and it is preferable, for example, to mix a toner particle and an external additive at 1000 to 5000 rpm for 5 to 20 minutes using a Henschel mixer (manufactured by Nippon Coke & Engineering Co., Ltd.).

### Method for Measuring Each Physical Property

Next, a method for measuring each physical property according to the present disclosure will be described.

### Method for Measuring Volume-Average Particle Diameter (Dv)

The volume-average particle diameter (Dv) of the toner is calculated in the following manner.

The measurement device used is a particle counting and analysis device “CDA-1000X” with a 100 μm aperture tube using a pore electrical resistance method (commercially available from Sysmex Corporation). The measurement conditions are set and measurement data is analyzed using bundled dedicated software “CDA-1000X (commercially available from Sysmex Corporation).”

As the electrolyte aqueous solution used for the measurement, for example, “Cellpack” (commercially available from Sysmex Corporation) can be used.

Here, before performing the measurement and analysis, dedicated software is set as follows.

On the “measurement condition setting” screen of the dedicated software, the total count number is set to 50,000, the number of repeated measurements is set to 1, and the measurement mode is set to the total count (no limit).

A specific measurement method is as follows.
(1) 150 mL of an electrolyte aqueous solution is put in a dedicated glass round-bottom beaker, then the beaker is mounted on a sample stage, and the solution is stirred with a stirring propeller at 500 rpm. Then, the “blank check measurement” of the dedicated software is clicked to start the measurement, and that the count number is less than 500 is confirmed. In a case where the count number is 500 or more, the beaker and aperture are washed repeatedly.
(2) 30 mL of the electrolyte aqueous solution is put into a 100 mL flat-bottomed glass beaker. 0.3 mL of a diluted solution prepared by diluting “Contaminon N” (a 10 mass % aqueous solution of a neutral detergent with pH 7 for washing precision measurement instruments, comprising a nonionic surfactant, an anionic surfactant, and an organic builder, commercially available from Wako Pure Chemical Industries, Ltd.) three mass times by weight with deionized water is added as a dispersing agent thereto.
(3) An ultrasonic disperser with an electrical output of 120 W “Ultrasonic Dispension System Tetra150” (commercially available from Nikkaki Bios Co., Ltd.), which incorporates two oscillators with an oscillation frequency of 50 kHz and with phases shifted by 180 degrees, is prepared. 3.3 L of deionized water is put into a water tank of the ultrasonic disperser, and 2 mL of Contaminon N is added to this water tank.
(4) The beaker in (2) is set in a beaker fixing hole of the ultrasonic disperser, and the ultrasonic disperser is operated. Then, the height position of the beaker is adjusted so that the resonance state of the liquid surface of the electrolyte aqueous solution in the beaker is maximized.
(5) While ultrasonic waves are emitted to the electrolyte aqueous solution in the beaker in (4), 10 mg of the toner is added little by little and dispersed. In addition, an ultrasonic dispersion treatment is additionally continued for 60 seconds. Here, during ultrasonic dispersion, the water temperature in the water tank is appropriately adjusted to be 10 to 40° C.
(6) The aqueous electrolyte solution mentioned in section (5) above, in which the toner is dispersed, is added dropwise by means of a pipette to the round bottomed beaker mentioned in section (1) above, which is disposed on the sample stand, and the measurement concentration is adjusted to 6%. Measurements are carried out until the number of particles measured reaches 50,000.
(7) The volume-average particle diameter (Dv) is calculated by analyzing measurement data using the accompanying dedicated software.

### Measurement of the Acid Value

The acid value is the number of milligrams of potassium hydroxide required to neutralize the acid present in 1 g of a sample. The acid value of the resin is measured in accordance with JIS K 0070-1992, and specifically is measured using the following procedure.

### (1) Reagent Preparation

1.0 g of phenolphthalein is dissolved in 90 mL of ethyl alcohol (95 vol %), and this is brought to 100 mL by the addition of deionized water to provide a phenolphthalein solution.

7 g of special-grade potassium hydroxide is dissolved in 5 mL of water and this is brought to 1 L by the addition of ethyl alcohol (95 vol %). This is introduced into an alkali-resistant container avoiding contact with, for example, carbon dioxide, and is allowed to stand for 3 days, after which time filtration is carried out to obtain a potassium hydroxide solution. The obtained potassium hydroxide solution is stored in an alkali-resistant container. The factor for this potassium hydroxide solution is determined from the amount of the potassium hydroxide solution required for neutralization when 25 mL of 0.1 mol/L hydrochloric acid is introduced into an Erlenmeyer flask, several drops of the phenolphthalein solution are added, and titration is performed using the potassium hydroxide solution. The 0.1 mol/L hydrochloric acid used is prepared in accordance with JIS K 8001-1998.

### (2) Procedure

### (A) Main Test

As a sample, the amorphous polyester resin separated from toner particles by the method described later is used.

A 2.0 g sample of the pulverized resin is exactly weighed into a 200-mL Erlenmeyer flask and 100 mL of a toluene/ethanol (2:1) mixed solution is added and dissolution is carried out over 5 hours. Several drops of the phenolphthalein solution are added as indicator and titration is performed using the potassium hydroxide solution. The titration endpoint is taken to be the persistence of the faint pink color of the indicator for 30 seconds.

### (B) Blank Test

The same titration as in the above procedure is run, but without using the sample (that is, with only the toluene/ethanol (2:1) mixed solution).

(3) the Acid Value is Calculated by Substituting the Obtained Results into the Following Formula.

$$A = [ ( C - B ) \times f \times 5.61 ] / S$$

Here, A: acid value (mg KOH/g), B: amount (mL) of addition of the potassium hydroxide solution in the blank test, C: amount (mL) of addition of the potassium hydroxide solution in the main test, f: factor for the potassium hydroxide solution, S: sample (g).

### Method for Measuring the Hydroxyl Value

The hydroxyl value is the number of milligrams of potassium hydroxide required to neutralize the acetic acid bonded with the hydroxyl group when 1 g of the sample is acetylated. The hydroxyl value of the binder resin is measured based on JIS K 0070-1992 and in specific terms is measured according to the following procedure.

### (1) Reagent Preparation

25 g of special-grade acetic anhydride is introduced into a 100-mL volumetric flask; the total volume is brought to 100 mL by the addition of pyridine; and thorough shaking then provides the acetylation reagent. The obtained acetylation reagent is stored in a brown bottle isolated from contact with, e.g., humidity, carbon dioxide, and so forth. A phenolphthalein solution is obtained by dissolving 1.0 g of phenolphthalein in 90 mL of ethyl alcohol (95 vol %) and bringing to 100 mL by the addition of deionized water.

35 g of special-grade potassium hydroxide is dissolved in 20 mL of water and this is brought to 1 L by the addition of ethyl alcohol (95 vol %). After standing for 3 days in an alkali-resistant container isolated from contact with, e.g., carbon dioxide, filtration is performed to obtain a potassium hydroxide solution. The obtained potassium hydroxide solution is stored in an alkali-resistant container. The factor for this potassium hydroxide solution is determined as follows: 25 mL of 0.5 mol/L hydrochloric acid is taken to an Erlenmeyer flask; several drops of the above-described phenolphthalein solution are added; titration is performed with the potassium hydroxide solution; and the factor is determined from the amount of the potassium hydroxide solution required for neutralization. The 0.5 mol/L hydrochloric acid used is prepared in accordance with JIS K 8001-1998.

### (2) Procedure

### (A) Main Test

A 1.0 g sample is exactly weighed into a 200-mL roundbottom flask and exactly 5.0 mL of the above-described acetylation reagent is added from a whole pipette. When the sample is difficult to dissolve in the acetylation reagent, dissolution is carried out by the addition of a small amount of special-grade toluene.

A small funnel is mounted in the mouth of the flask and heating is then carried out by immersing 1 cm of the bottom of the flask in a glycerol bath at approximately 97° C. In order at this point to prevent the temperature at the neck of the flask from rising due to the heat from the bath, heavy paper in which a round hole has been made is preferably mounted at the base of the neck of the flask.

After 1 hour, the flask is taken off the glycerol bath and allowed to cool. After cooling, the acetic anhydride is hydrolyzed by adding 1 mL of water from the funnel and shaking. In order to accomplish complete hydrolysis, the flask is again heated for 10 minutes on the glycerol bath. After cooling, the funnel and flask walls are washed with 5 mL of ethyl alcohol.

Several drops of the above-described phenolphthalein solution are added as the indicator and titration is performed using the above-described potassium hydroxide solution. The endpoint for the titration is taken to be the point at which the pale pink color of the indicator persists for 30 seconds.

### (B) Blank Test

Titration is performed using the same procedure as described above, but without using the sample.

(3) the Hydroxyl Value is Calculated by Substituting the Obtained Results into The Following Formula.

$$A = [ \{ ( B - C ) \times 28.05 \times f \} / S ] + D$$

Here, A: hydroxyl value (mg KOH/g); B: amount of addition (mL) of the potassium hydroxide solution in the blank test; C: amount of addition (mL) of the potassium hydroxide solution in the main test; f: factor for the potassium hydroxide solution; S: sample (g); and D: acid value (mg KOH/g) of the sample.

Measurement of Molecular Weights of Amorphous Resin, Amorphous Polyester Resin, and Crystalline Vinyl Resin

The molecular weight (weight-average molecular weight Mw) of the amorphous resin, the amorphous polyester resin, and the crystalline vinyl resin are measured by gel permeation chromatography (GPC) as follows. As a sample, an amorphous resin, an amorphous polyester resin, or a crystalline vinyl resin separated from the toner particle according to the method described below can be used.

First, the sample is dissolved in tetrahydrofuran (THF) at room temperature for 24 hours. The obtained solution is filtered using a “Sample Pretreatment Cartridge” (Tosoh Corporation) solvent-resistant membrane filter having a pore diameter of 0.2 μm to obtain a sample solution. The sample solution is adjusted to a concentration of THF-soluble matter of 0.8 mass %. Measurement is carried out under the following conditions using this sample solution.
instrument: HLC8120 GPC (detector: RI) (Tosoh Corporation)
column: 2-column train of Shodex LF-404, LF-404 (Showa Denko Kabushiki Kaisha)
eluent: tetrahydrofuran (THF)
flow rate: 1.0 mL/min
oven temperature: 40.0° C.
sample injection amount: 0.10 mL

A molecular weight calibration curve constructed using polystyrene resin standards (for example, product name “TSK Standard Polystyrene F-850, F-450, F-288, F-128, F-80, F-40, F-20, F-10, F-4, F-2, F-1, A-5000, A-2500, A-1000, A-500”, Tosoh Corporation) is used to determine the molecular weight of the sample.

Separation of Toner Particle from Toner

By the following method, the toner particle obtained by separating the toner particle and the external additive can be used for each analysis.

Sucrose (manufactured by Kishida Chemical Co., Ltd.): 160 g is added to 100 mL of ion exchanged water and dissolved in a hot water bath to prepare an aqueous sucrose solution. Into a centrifuge tube, 31 g of the aqueous sucrose solution and 6 mL of Contaminon N (a 10% by mass aqueous solution of a neutral detergent with pH 7 for washing precision measurement instruments, including a nonionic surfactant, an anionic surfactant, and an organic builder, manufactured by FUJIFILM Wako Pure Chemical Corporation) are put to prepare a dispersion. To this dispersion, 1 g of the toner is added, and the toner lump is loosened with a spatula or the like.

The centrifuge tube is set in “KM Shaker” (model: V SX) manufactured by IWAKI CO., LTD., and shaken under the condition of 350 reciprocations per minute for 20 minutes. After the shaking, the solution is transferred into a glass tube (50 mL) for a swing rotor, and centrifuged under the condition of 3500 rpm for 30 minutes in a centrifuge.

In the glass tube after the centrifugation, the toner particle exists in the uppermost layer, whereas the external additives, such as a silica fine particle, exist on the lower layer aqueous solution side. The toner particle in the upper layer is collected and filtered, and washed by passing 2 L of ion exchanged water warmed to 40° C., and the washed toner particle is taken out.

### Measurement Method of Time-of-Flight Secondary Ion Mass Spectrometry (TOF-SIMS) of Toner Particle

In the TOF-SIMS analysis, external additives are removed from the toner by the method described above, and the toner particle is then measured. For the measurement of the ion amount (peak intensity) using TOF-SIMS, TRIFT-IV manufactured by ULVAC-PHI, Inc., is used.

Analysis conditions are as follows.
Sample adjustment: the toner particle is attached to an indium sheet
Sample pretreatment: none
Primary ion species: Au ions
Acceleration voltage: 30 kV
Charge neutralization mode: On
Measurement mode: positive
Raster: 200 μm
Measurement time: 60 s

Usually, TOF-SIMS is a surface analysis method, and the data in the depth direction is the data of approximately 1 nm depth. Therefore, the strength inside the toner particle is measured by sputtering the toner particle with argon gas cluster ions and grinding the surface of the toner particle. The depth was measured in advance by sputtering a PMMA standard sample film under the same conditions to confirm the relationship with irradiation time.

The sputtering conditions used in this embodiment are as follows.
Acceleration voltage: 5 kV
Current: 3.5 nA
Raster: 400 μm
Irradiation time: 4 s

Under these sputtering conditions, it was confirmed that 40 sputtering cycles removed 20 nm of the PMMA standard sample film. Therefore, TOF-SIMS analysis was performed while sputtering up to 40 cycles.

Calculation Method of A(max)/A (min)

According to the standard software (Win Cadense) of ULVAC-PHI, Inc., the total count number of the mass numbers of the structure represented by formula (A), that is, 53.0 to 53.1 (when R¹ is a hydrogen atom) and 67.0 to 67.1 (when R¹ is a methyl group), are taken as the ion amount of the structure represented by formula (A) (secondary ion mass/secondary ion charge number (m/z))). The value obtained by dividing the ion amount by the total ion amount counted in the measurement of the toner particle is taken as a standard value.

For the standard value measured while sputtering 0 to 40 times under the above conditions, a chart with an x-axis representing time and a y-axis representing the ion amounts corresponding to the monomer unit (A) is prepared, and the maximum value of the ion amounts obtained is taken as A(max), and the minimum value is taken as A (min). From the A(max) and A (min) obtained, A(max)/A (min) is calculated.

Calculation Method of d (min)

The time when A (min) is detected described above is converted into the thickness of the polymethyl methacrylate standard sample film sputtered to calculate d (min). In other words, d (min) corresponds to the thickness of the PMMA standard sample film sputtered within a time period from the start of measurement to the time at which A (min) is detected.

Specifically, d (min) is calculated in the following manner.

To remove 20 nm of a PMMA standard sample film under the above sputtering conditions requires the time equivalent to 40 sputtering cycles. For example, if A (min) is detected when the 24th sputtering cycle is completed, d (min) corresponding to the time equivalent to 24 sputtering cycles is 12 nm.

### Method of Observing Cross-Section of Toner in Transmission Electron Microscope (TEM)

The coverage ratio of a toner particle with an amorphous resin can be determined by observing the morphology of the cross-section of each toner particle. A specific method of observing the morphology of the cross-section of each toner particle is as follows.

First, the toner particle is sufficiently dispersed in the photo-curable epoxy resin, and then the epoxy resin is cured by irradiation with ultraviolet rays. The resulting cured product is cut with a microtome provided with a diamond knife to prepare a 100-nm-thick thin slice sample.

The thin slice sample is stained for 15 minutes using a vacuum staining apparatus (VSC4R1H, manufactured by Filgen, Inc.) in a RuO4 gas 500-Pa atmosphere, and the cross-section of a toner particle is observed using a transmission electron microscope (TEM) (trade name: Tecnai TF20XT, manufactured by FEI Company) at an acceleration voltage of 120 kV to acquire a TEM image.

In this case, as the cross-section of the toner particle, a cross-section with a major axis diameter that is 0.9 to 1.1 times the volume-average particle diameter (Dv) when the toner is measured is selected according to the measuring method of the volume-average particle diameter (Dv) of the toner particle described above.

In the above observation method, the amorphous resin in the toner particle is strongly stained with ruthenium tetroxide. As a result, the shell portion mainly composed of the amorphous resin is stained, and the core portion mainly composed of an unstained crystalline vinyl resin can be observed as a contrast. Here, the observation magnification is 20000.

On the basis of the TEM image thus obtained, the length C1 (nm) of a portion where shell layers are observed among the peripheral length of one toner particle and the peripheral length C2 (nm) of one toner particle are calculated in the cross-section of each toner particle, and (C1/C2)×100(%) is taken as the coverage ratio with an amorphous resin.

This measurement is performed for 100 toner particles, and the arithmetic mean value thereof is employed.

### Method for Calculating SP Value

The SP values of the crystalline vinyl resin, amorphous polyester resin, and ester wax are determined as follows according to the calculation method proposed by Fedors.

When the SP value (cal/cm³)^{0.5} is calculated, an evaporation energy (Δei) (cal/mol) and a molar volume (Δvi) (cm³/mol) are determined from the table described in “Polym. Eng. Sci., 14(2), 147-154 (1974)” with respect to atoms or atomic groups in the identified molecular structure, and the SP value is calculated by the following expression.

$$SP value of ester wax = {( \sum Δ ei / \sum Δ vi )}^{0.5}$$

Calculation Method of Content of Unit Represented by formula (B) in Polyester Resin and Content of Units Represented by Formulas (A) and (A2) in Crystalline Vinyl Resin in Toner Particle

The content of the unit represented by formula (B) in the polyester resin and the content of the units represented by formulas (A) and (A2) in the crystalline vinyl resin in the toner particle are determined by separating the polyester resin and the crystalline vinyl resin from a toner, then identifying the structure of each resin, and calculating the content of each monomer unit by ¹H-NMR of the toner particle on the basis of the identified amorphous resin and crystalline structure.

In a method of separating an amorphous polyester resin and a crystalline vinyl resin from a toner particle, first, resins and chloroform-insoluble matter in the toner particle are separated, and each content is calculated.

Specifically, 1.5 g of a toner particle is precisely weighed, put in a cylindrical filter paper (trade name: No. 86R, size: 28×100 mm, manufactured by Advantec Toyo Kaisha, Ltd.), which has been precisely weighed in advance, and set in a Soxhlet extractor. Extraction is performed for 18 hours using 200 mL of chloroform as a solvent, at a reflux rate such that the extraction cycle of the solvent is once every 5 minutes.

After the completion of the extraction, the cylindrical filter paper is taken out and air-dried, then vacuum-dried at 40° C. for 8 hours. The mass of the cylindrical filter paper is subtracted from the weighed mass of the cylindrical filter paper containing the extraction residue to calculate the mass (W3 [g]) of the extraction residue (chloroform-insoluble matter). Furthermore, when recovering the chloroform-soluble matter (W2 [g]), the chloroform-soluble matter can be recovered by sufficiently evaporating chloroform from the soluble matter in chloroform using an evaporator.

Next, the content (W4 [g]) of resin components in the chloroform-insoluble matter is determined in the following procedure.

In a 30-mL magnetic crucible that has been weighed in advance, 2 g of chloroform-insoluble matter of a toner particle is precisely weighed (Wa′ [g]).

The magnetic crucible is placed in an electric furnace, heated at 900° C. for 3 hours, allowed to cool in the electric furnace, and allowed to cool in a desiccator at normal temperature for at least 1 hour, the mass of the crucible containing an incineration ash content is weighed, and the mass of the crucible is subtracted to calculate the incineration ash residue (Wb′ [g]).

Then, the mass (W5 [g]) of the incineration ash content in the sample W1 [g] is calculated by the following expression.

$$W 5 = W 1 \times ( {Wb}^{′} / {Wa}^{′} )$$

Next, the mass (W4 [g]) of the resin component excluding incineration ash content in the chloroform-insoluble fraction of toner particle is calculated by the following expression.

$$W 4 = W 3 - W 5$$

Then, the release agent in the toner particle is separated. The separation of a resin and a release agent in a toner particle is performed by recycling HPLC, identifying components with molecular weights of 2000 or less as the release agent. The measurement method is as follows.

First, chloroform-soluble matter is separated by the method described above and re dissolved in chloroform. Then, the resulting solution is filtered through a solvent-resistant membrane filter with a pore diameter of 0.2 μm, “Maishori Disc” (manufactured by Tosoh Corporation) to obtain a sample solution. The sample solution is adjusted such that the concentration of the components that are soluble in the chloroform is 1.0% by mass. The sample solution is used to perform measurements under the following conditions.
Apparatus: LC-Sakura NEXT (manufactured by Japan Analytical Industry Co., Ltd.)
Column: JAIGEL2H, 4H (manufactured by Japan Analytical Industry Co., Ltd.)
Eluent: chloroform
Flow rate: 10.0 mL/min
Oven Temperature: 40.0° C.
Sample Injection Amount: 1.0 mL

For the calculation of the molecular weight of the sample, a molecular weight calibration curve is used, which is created using standard polystyrene resins (for example, trade names “TSK standard polystyrene F-850, F-450, F-288, F-128, F-80, F-40, F-20, F-10, F-4, F-2, F-1, A-5000, A-2500, A-1000, and A-500” manufactured by Tosoh Corporation).

From the molecular weight curve thus obtained, components with molecular weights of 2000 or less are repeatedly isolated to separate the resin component (W) and the release agent component (Wd) from the chloroform-soluble matter of the toner. Then, the content (W6 [g]) of the resin components in the chloroform-soluble matter (W2) in the toner particle (W1) is calculated by the following expressions.

$$W 2 = W 1 - W 3$$

$$W 6 = W 2 \times ( W / ( W + W d ) )$$

For the separation of the amorphous resin and the crystalline vinyl resin from the toner particle, the resin component (W6) in the chloroform-soluble matter of the toner particle is used as a sample.

A sample is adjusted in chloroform so that the sample concentration be 1.0% by mass, and the solution is filtered through a 0.45 μm PTFE filter, which is then subjected to measurement. The gradient polymer LC measurement conditions are shown below. Apparatus: UlTIMATE 3000 (manufactured by Thermo Fisher Scientific)
Mobile phase: A chloroform (HPLC), B acetonitrile (HPLC)
Gradient: 2 min (A/B=0/100) →25 min (A/B=100/0) (Note that the gradient of the change in the mobile phase should be linear)
Flow velocity: 1.0 mL/min
Injection: 1.0% by mass×20 μL
Column: Tosoh TSKgel ODS (4.6 mm diameter×150 mm length×5 μm)
Column temperature: 40° C.
Detector: Corona charged aerosol detector (Corona-CAD) (manufactured by Thermo Fisher Scientific)

For the graph of the time-signal intensity (A) obtained in the measurement, the time is converted to the percentage of chloroform (vol %). Thereafter, acetonitrile/chloroform solution-soluble matter is obtained from the resin in the chloroform-soluble matter using an acetonitrile/chloroform solution according to the volume fraction corresponding to the observed maximum.

For the thus-obtained acetonitrile/chloroform solution-soluble matter according to the maximum value, the structures of the amorphous resin (amorphous polyester resin and styrenic vinyl resin) and the crystalline vinyl resin are identified using a pyrolysis gas chromatography mass spectrometer (hereinafter referred to as pyrolysis GC/MS) and NMR.
¹H-NMR is conducted in the following conditions.
Measurement Apparatus: FT NMR apparatus JNM-EX400 (manufactured by JEOL Ltd.)
Measurement frequency: 400 MHz
Pulse Condition: 5.0 s
Frequency range: 10500 Hz
Accumulation count: 64 times
Measurement temperature: 30° C.
Sample: prepared as follows

Into a sample tube of 5 mm in inner diameter, 50 mg of a measurement sample is put, with deuterated chloroform (CDCl₃) is added thereto as a solvent, and dissolved in a thermostatic chamber at 40° C. to prepare a sample.

The resulting ¹H-NMR chart is analyzed, and the structure of each monomeric unit is identified. Here, as an example, the measurement of the content proportion of the monomer unit (A) represented by formula (A) in a crystalline vinyl resin will be described.

In the obtained ¹H-NMR chart, a peak independent of peaks attributed to constituents of other monomer units is selected among the peaks attributed to constituents of the crystalline vinyl resin containing the monomer unit (A), and the integration value S1 of this peak is calculated. The integration values of other monomer units contained in the crystalline vinyl resin are calculated in the same manner.

When the monomer units constituting the crystalline vinyl resin are only the monomer unit (A) and one other monomer unit, the content proportion of the monomer unit (A) is determined as follows using the integration value S1 and the integration value S2 of the peak of the other monomer unit. Here, n1 and n2 are the numbers of hydrogen atoms in constituents to which the peak of interest for each segment belongs.

$$The content of the monomer unit ( A ) ( mol \% ) = \{ ( S 1 / n 1 ) / ( ( S 1 / n 1 ) + ( S 2 / n 2 ) ) \} \times 100$$

When there are two or more types of other monomer units, the content proportion of the monomer unit (A) can be calculated in the same manner using (S3 Sx, n3 . . . nx).

Here, when a monomer containing no hydrogen atom is used as constients other than vinyl groups, the measurement nucleus is set to ¹³C using ¹³C-NMR, measurement is performed in a single pulse mode, and the proportion of monomer units is calculated in the same manner as for ¹H-NMR.

The proportion (mol %) of each monomer unit calculated by the above method is multiplied by the molecular weight of each monomeric unit to convert the content proportion of each monomer unit to the unit of % by mass.

From the content (W6 [g]) of resin components in the toner particle (W1 [g]) described above and the content proportion of each monomer unit (% by mass), the content of each monomer unit in the binder resin can be calculated.

The content of the styrenic vinyl resin in the binder resin (mass proportion WA (% by mass)), the content of the amorphous polyester resin (mass proportion WB (% by mass)), and the content of the crystalline vinyl resin (mass proporiton WC (% by mass)) can be calculated in the same manner.

### EXAMPLES

The present disclosure is more particularly described below using examples and comparative examples. Insofar as the essential features of the present disclosure are not exceeded, the present disclosure is in no way limited by the following examples. In the following text of the examples, “parts” is on a mass basis unless specifically indicated otherwise.

### Preparation of Crystalline Vinyl Resin 1

The following materials were put in a reaction vessel equipped with a reflux cooling tube, a stirrer, a thermometer, and a nitrogen inlet tube under a nitrogen atmosphere.
Toluene: 100.0 parts by mass
Monomer composition: 100.0 parts by mass
(the monomer composition is a mixture of the following monomers in the following proportions)
Behenyl acrylate: 60.0 parts by mass
Styrene: 20.0 parts by mass
Acrylonitrile: 10.0 parts by mass
N-vinyl-2-pyrrolidone: 10.0 parts by mass
Polymerization initiator, t-butyl peroxypivalate (PERBUTYL PV manufactured by NOF Corporation): 0.5 parts by mass

While stirring the inside of the above reaction vessel at 200 rpm, the reaction vessel was heated to 70° C., and a polymerization reaction was performed for 12 hours to obtain a solution in which the polymer of the monomer composition was dissolved in toluene. Subsequently, the temperature of the solution was lowered down to 25° C., and then, the solution was put into 1000.0 parts of methanol while stirring to precipitate a methanol-insoluble matter. The obtained methanol-insoluble matter was separated by filtration, further washed with methanol, and then vacuum-dried at 40° C. for 24 hours to obtain a crystalline vinyl resin A1. Physical properties of the crystalline vinyl resin 1 are shown in Table 1.

### Preparation of Crystalline Vinyl Resins 2 to 13

Crystalline vinyl resins 2 and 13 were prepared in the same manner as in the preparation of the crystalline vinyl resin 1, except that the types and amounts of the monomer composition added were changed as shown in Table 1. The physical properties of the crystalline vinyl resin 2 to 13 are shown in Table 1.

### Preparation of Amorphous Vinyl Resin 1

The following materials were put into a reaction vessel equipped with a reflux cooling tube, a stirrer, a thermometer, and a nitrogen inlet tube under a nitrogen atmosphere.
Toluene: 100.0 parts by mass
Styrene: 71.8 parts by mass
Butyl acrylate: 28.0 parts by mass
1,6-Hexanediol diacrylate: 0.2 parts by mass
   Polymerization initiator t-butyl peroxypivalate (PERBUTYL PV manufactured by NOF Corporation): 0.8 parts by mass

The above materials were heated to 70° C. in the reaction vessel with stirring at 200 rpm, and a polymerization reaction was performed for 12 hours to obtain a solution in which the polymer in the monomer composition was dissolved in toluene. Subsequently, the temperature of the solution was lowered to 25° C., and then, the solution was put into 1000.0 parts by mass of methanol while stirring to precipitate a methanol-insoluble matter. The obtained methanol-insoluble matter was separated by filtration, further washed with methanol, and then vacuum-dried at 40° C. for 24 hours to obtain an amorphous resin 1.

The amorphous vinyl resin 1 had a weight-average molecular weight of 33000, a glass transition temperature (Tg) of 65° C., and an acid value of 0.0 mgKOH/g.

TABLE 1

| | Monomer (A) | | Monomer (A2) | | | Other monomer 1 | | Other monomer 2 | | Physical property | |
|---|---|---|---|---|---|---|---|---|---|---|---|
| | | Amount | | Carbon | Amount | | Amount | | Amount | | Molecular |
| | | added | | number | added | | added | | added | SP | weight |
| | Type | (parts) | Type | n | (parts) | Type | (parts) | Type | (parts) | value | Mw |
| Crystalline vinyl | Acrylonitrile | 10 | Behenyl acrylate | 21 | 60 | Styrene | 20 | N-vinyl-2- | 10 | 21.5 | 25000 |
| resin 1 | | | | | | | | pyrrolidone | | | |
| Crystalline vinyl | Methacrylonitrile | 5 | Behenyl acrylate | 21 | 80 | — | 0 | N-vinyl-2- | 15 | 20.7 | 26000 |
| resin 2 | | | | | | | | pyrrolidone | | | |
| Crystalline vinyl | Acrylonitrile | 10 | Stearyl acrylate | 17 | 70 | Styrene | 15 | N-vinyl-2- | 5 | 20.2 | 26000 |
| resin 3 | | | | | | | | pyrrolidone | | | |
| Crystalline vinyl | Acrylonitrile | 15 | Behenyl acrylate | 21 | 70 | Styrene | 10 | Acrylic acid | 5 | 20.5 | 27000 |
| resin 4 | | | | | | | | | | | |
| Crystalline vinyl | Acrylonitrile | 15 | Behenyl acrylate | 21 | 70 | Styrene | 15 | — | 0 | 20.5 | 28000 |
| resin 5 | | | | | | | | | | | |
| Crystalline vinyl | Acrylonitrile | 10 | Behenyl acrylate | 21 | 70 | Styrene | 20 | — | 0 | 20.2 | 30000 |
| resin 6 | | | | | | | | | | | |
| Crystalline vinyl | Acrylonitrile | 10 | Myricyl acrylate | 29 | 85 | Styrene | 5 | — | 0 | 19.6 | 32000 |
| resin 7 | | | | | | | | | | | |
| Crystalline vinyl | Acrylonitrile | 25 | Behenyl acrylate | 21 | 50 | Styrene | 25 | — | 0 | 21.3 | 30000 |
| resin 8 | | | | | | | | | | | |
| Crystalline vinyl | Acrylonitrile | 30 | Behenyl acrylate | 21 | 60 | Styrene | 10 | — | 0 | 21.5 | 30000 |
| resin 9 | | | | | | | | | | | |
| Crystalline vinyl | Acrylonitrile | 20 | Behenyl acrylate | 21 | 80 | — | 0 | — | 0 | 20.7 | 32000 |
| resin 10 | | | | | | | | | | | |
| Crystalline vinyl | Acrylonitrile | 35 | Behenyl acrylate | 21 | 45 | Styrene | 10 | Acrylic acid | 10 | 22.5 | 26000 |
| resin 11 | | | | | | | | | | | |
| Crystalline vinyl | Acrylonitrile | 10 | Behenyl acrylate | 21 | 90 | — | 0 | — | 0 | 19.4 | 28000 |
| resin 12 | | | | | | | | | | | |
| Crystalline vinyl | — | 0 | Behenyl acrylate | 21 | 95 | Styrene | 5 | — | 0 | 18.8 | 28000 |
| resin 13 | | | | | | | | | | | |

### Synthesis of Amorphous Polyester Resin 1

Bisphenol A-propylene oxide 2 mol adduct: 1000 parts by mass
Isophthalic acid: 210 parts by mass
Dodecenylsuccinic acid: 310 parts by mass

The monomers described above were added to a flask equipped with a stirring device, a nitrogen inlet tube, a temperature sensor, and a rectification column. The temperature was raised to 195° C. over 1 hour, and it was confirmed that the inside of the reaction system was uniformly stirred. To 100 parts of the monomer described above, 1.2 parts by mass of tin distearate were added. The temperature was further raised from 195° C. to 240° C. over 5 hours while the generated water was distilled off, and a dehydration condensation reaction was further performed at 240° C. for 2 hours. Next, the temperature was lowered to 190° C., 25 parts by mass of trimellitic anhydride was gradually added, and the reaction continued at 190° C. for 1 hour.

As a result, an amorphous polyester resin 1 having an acid value of 6.0 mgKOH/g, a hydroxyl value of 30.5 mgKOH/g, and a weight-average molecular weight of 15000 was obtained.

### Synthesis of Amorphous Polyester Resins 2 to 21

Amorphous polyester resins 2 to 21 were obtained in the same manner as in the synthesis example of the amorphous polyester resin 1, except that the compositions were changed as shown in Table 2 in the synthesis example of the amorphous polyester resin 1.

The analysis results of the amorphous polyester resins 2 to 21 are shown in Table 2.

TABLE 2

| | | | | | | | | | Physical property | | | |
|---|---|---|---|---|---|---|---|---|---|---|---|---|
| | | | | Acid monomer | | | | Monomer | Monomer | Acid | | |
| | Alcohol monomer | | | | | Sebacic | Trimellitic | unit (B) | unit (B) | value | Molecular | SP(B) |
| | BPA-2PO | BPA-2EO | EG | TPA | IPA | acid | anhydride | DSA | (% by mass) | (KOH/g) | weight | [(J/cm³)^{0.5}] |
| Amorphous | 1000 | — | — | — | 210 | — | 25 | 310 | 25.1 | 6.3 | 16000 | 21.7 |
| polyester | | | | | | | | | | | | |
| resin 1 | | | | | | | | | | | | |
| Amorphous | 950 | — | 50 | 70 | 70 | — | 20 | 620 | 53.4 | 5.2 | 14000 | 21.3 |
| polyester | | | | | | | | | | | | |
| resin 2 | | | | | | | | | | | | |
| Amorphous | 1000 | — | — | — | 120 | — | 20 | 480 | 42.1 | 4.8 | 15000 | 21.5 |
| polyester | | | | | | | | | | | | |
| resin 3 | | | | | | | | | | | | |
| Amorphous | 1000 | — | — | — | 120 | — | 15 | 480 | 42.3 | 4.0 | 15000 | 21.5 |
| polyester | | | | | | | | | | | | |
| resin 4 | | | | | | | | | | | | |
| Amorphous | 1000 | — | — | — | 120 | — | 25 | 480 | 41.9 | 6.2 | 17000 | 21.5 |
| polyester | | | | | | | | | | | | |
| resin 5 | | | | | | | | | | | | |
| Amorphous | 1000 | — | — | — | 120 | — | 15 | 480 | 42.3 | 3.0 | 14000 | 21.5 |
| polyester | | | | | | | | | | | | |
| resin 6 | | | | | | | | | | | | |
| Amorphous | 1000 | — | — | — | 120 | — | 60 | 480 | 40.7 | 16.8 | 18000 | 21.5 |
| polyester | | | | | | | | | | | | |
| resin 7 | | | | | | | | | | | | |
| Amorphous | 1000 | — | — | — | 120 | — | 70 | 480 | 40.3 | 19.7 | 17000 | 21.5 |
| polyester | | | | | | | | | | | | |
| resin 8 | | | | | | | | | | | | |
| Amorphous | 1000 | — | — | — | 120 | — | 25 | 480 | 41.9 | 6.1 | 24000 | 21.5 |
| polyester | | | | | | | | | | | | |
| resin 9 | | | | | | | | | | | | |
| Amorphous | 1000 | — | — | — | 120 | — | 25 | 480 | 41.9 | 6.0 | 29000 | 21.5 |
| polyester | | | | | | | | | | | | |
| resin 10 | | | | | | | | | | | | |
| Amorphous | 1000 | — | — | — | 120 | — | 25 | 480 | 41.9 | 6.2 | 11000 | 21.5 |
| polyester | | | | | | | | | | | | |
| resin 11 | | | | | | | | | | | | |
| Amorphous | 1000 | — | — | — | 160 | — | — | 480 | 41.4 | 6.1 | 8000 | 21.5 |
| polyester | | | | | | | | | | | | |
| resin 12 | | | | | | | | | | | | |
| Amorphous | 900 | — | 100 | — | 180 | — | — | 790 | 66.9 | 6.0 | 9000 | 21.1 |
| polyester | | | | | | | | | | | | |
| resin 13 | | | | | | | | | | | | |
| Amorphous | 950 | — | 50 | — | 450 | — | — | 200 | 13.8 | 6.2 | 9000 | 22.3 |
| polyester | | | | | | | | | | | | |
| resin 14 | | | | | | | | | | | | |
| Amorphous | 1000 | — | — | — | 410 | — | — | 80 | 5.7 | 6.0 | 9000 | 22.5 |
| polyester | | | | | | | | | | | | |
| resin 15 | | | | | | | | | | | | |
| Amorphous | 1000 | — | — | — | 330 | 160 | — | — | 0.0 | 6.3 | 9000 | 22.1 |
| polyester | | | | | | | | | | | | |
| resin 16 | | | | | | | | | | | | |
| Amorphous | 1000 | — | — | — | 300 | 150 | — | — | 0.0 | 3.0 | 9000 | 22.1 |
| polyester | | | | | | | | | | | | |
| resin 17 | | | | | | | | | | | | |
| Amorphous | 450 | 450 | 100 | — | 140 | 650 | — | — | 0.0 | 3.1 | 9000 | 20.9 |
| polyester | | | | | | | | | | | | |
| resin 18 | | | | | | | | | | | | |
| Amorphous | 300 | 700 | — | — | 330 | 160 | 60 | — | 0.0 | 17..5 | 9000 | 22.1 |
| polyester | | | | | | | | | | | | |
| resin 19 | | | | | | | | | | | | |
| Amorphous | 450 | 450 | 100 | — | 90 | 700 | — | — | 0.0 | 3.2 | 9000 | 20.9 |
| polyester | | | | | | | | | | | | |
| resin 20 | | | | | | | | | | | | |
| Amorphous | 1000 | — | — | — | 420 | — | — | — | 0.0 | 3.0 | 9000 | 22.3 |
| polyester | | | | | | | | | | | | |
| resin 21 | | | | | | | | | | | | |

The abbreviations in the tables are as follows.
BPA-2PO: bisphenol A propylene oxide 2 mol adduct
BPA-2EO: bisphenol A ethylene oxide 2 mol adduct
EG: ethylene glycol
TPA: terephthalic acid:
IPA: isophthalic acid
DSA: dodecenylsuccinic acid

### Production of Toner 1

### Production of Toner by Suspension Polymerization Method

### Production of Toner Particle 1

n-Butyl acrylate: 15.0 parts
Styrene: 45.0 parts
Colorant Pigment Blue 15:3: 6.5 parts

A mixture including the above materials was prepared. The mixture was put into an attritor (manufactured by Nippon Coke & Engineering Co., Ltd.), and dispersion was performed using zirconia beads with a diameter of 5 mm at 200 rpm for 2 hours to obtain a raw material dispersion.

Separately, 735.0 parts of ion exchanged water and 16.0 parts of trisodium phosphate (12 hydrate) were added to a container equipped with a high-speed stirrer Homo Mixer (manufactured by PRIMIX Corporation) and a thermometer, and while stirring the mixture at 12000 rpm, the temperature was raised to 60° C. To the mixture, an aqueous calcium chloride solution obtained by dissolving 9.0 parts of calcium chloride (dihydrate) in 65.0 parts of ion exchanged water was added, and the mixture was stirred at 12000 rpm for 30 minutes while maintaining 60° C. To the mixture, a 10% aqueous sodium carbonate solution was added to adjust the pH to 8.0, thereby providing an aqueous medium in which an inorganic dispersion stabilizer containing hydroxyapatite was dispersed in water.

Subsequently, the raw material dispersion was transferred to a container equipped with a stirring apparatus and a thermometer, and heated to 60° C. while stirring at 100 rpm. The following materials were added thereto, and the mixture was stirred at 100 rpm for 30 minutes while maintaining the temperature at 60° C.
Crystalline vinyl resin 1: 40.0 parts
Amorphous polyester resin 1: 6.0 parts
1,6-Hexanediol diacrylate: 0.1 parts
DP18 (dipentaerythritol stearate wax, manufactured by The Nisshin OilliO Group, Ltd.): 9.0 parts

After stirring, 5.0 parts of t-butyl peroxypivalate (PERBUTYL PV, manufactured by NOF Corporation) as a polymerization initiator was added, and the mixture was stirred for another 1 minute and then put in an aqueous medium that was being stirred at 12000 rpm using the high-speed stirring apparatus. While maintaining the temperature at 60° C., stirring was continued at 12000 rpm for 20 minutes using the high-speed stirring apparatus to obtain a granulation liquid.

The granulation liquid was transferred to a reaction vessel equipped with a reflux cooling tube, a stirrer, a thermometer, and a nitrogen inlet tube and heated to 76.0° C. under a nitrogen atmosphere while stirring at 150 rpm. While maintaining the temperature at 76.0° C., a polymerization reaction was performed at 150 rpm for 6.0 hours to obtain a toner particle dispersion.

The obtained toner particle dispersion was cooled to 45° C. while stirring at 150 rpm and then heated for 5 hours while maintaining at 45° C. Then, while maintaining stirring, dilute hydrochloric acid was added until the pH reached 1.5 to dissolve the dispersion stabilizer. The solid content was filtered off, sufficiently washed with deionized water, and then vacuum-dried at 30° C. for 24 hours to obtain a toner particle 1.

### Production of Toner Particles 2 to 26 and Comparative Toner Particles 1 to 6

Toners 2 to 26 and comparative toners 1 to 6 were obtained in the same manner as in the production of the toner 1, except that the materials and the reaction conditions were changed to those shown in Table 3.

### Manufacturing of Toner Particle 27

### Production of Core Particle 27

A toner particle 27 was produced through the core particle formation step by a melt kneading and pulverization method, and the shell layer formation step.
Crystalline vinyl resin 8: 30.0 parts by mass
Amorphous vinyl resin 1: 70.0 parts by mass
DP18: 9.0 parts by mass
Colorant Pigment Blue 15:3: 6.5 parts by mass
Aluminum stearate: 0.03 parts by mass

The above materials were pre-mixed by a Henschel mixer (manufactured by Nippon Coke & Engineering Co., Ltd.) and then melt-kneaded using a twin-screw kneading extruder (PCM-30, manufactured by Ikegai Tekko K.K.) while setting the temperature and the rotational speed so that the melt temperature at the discharge port be 140° C.

The obtained kneaded product was cooled, coarsely pulverized with a hammer mill, and then pulverized with a mechanical pulverizer (T-250 manufactured by Turbo Kogyo K.K.). The obtained finely pulverized powder was classified using a multi-grade classifier utilizing a Coanda effect to obtain a core particle 27.

### Dispersion Preparation Step

To 250.0 parts of ion exchange water heated to a temperature of 40° C., 1.8 parts of calcium phosphate was added as a dispersing agent, and the mixture was stirred using a T.K. Homomixer (manufactured by Tokushu Kika Kogyo Co., Ltd.) at stirring speed of 15000 rpm to prepare an aqueous medium.

To an aqueous medium, 115.5 parts of a core particle 27 were added to prepare a core particle dispersion 27.

### Shell Layer Formation Step

To add 8.0 parts of the amorphous polyester resin 1 to 115.5 parts of a core particle 27, 16.0 parts of an aqueous dispersion of the amorphous polyester resin 1 with a solid content of 50.0% by mass was added to the core particle dispersion 27. Then, the temperature of the aqueous medium was raised to 75° C. and maintained for 2 hours to form a shell layer on the surface of the core particle. After cooling to room temperature, hydrochloric acid was added to dissolve calcium phosphate, which was a dispersing agent, followed by filtration, washing with water, and drying to obtain a toner particle 27 having a core-shell structure.

### Production of Comparative Toner 7

The comparative toner particle 7 was produced by a melt kneading and pulverization method.
Crystalline vinyl resin 8: 30.0 parts by mass
Amorphous vinyl resin 1: 70.0 parts by mass
Amorphous polyester resin 1: 6.0 parts by mass
DP18: 9.0 parts by mass
Colorant Pigment Blue 15:3: 6.5 parts by mass
Aluminum stearate: 0.03 parts by mass

The above materials were pre-mixed by a Henschel mixer (manufactured by Nippon Coke & Engineering Co., Ltd.) and then melt-kneaded using a twin-screw kneading extruder (PCM-30, manufactured by Ikegai Tekko K.K.) while setting the temperature and the rotational speed so that the melt temperature at the discharge port be 140° C.

The obtained kneaded product was cooled, coarsely pulverized with a hammer mill, and then pulverized with a mechanical pulverizer (T-250 manufactured by Turbo Kogyo K.K.). The obtained finely pulverized powder was classified using a multi-grade classifier utilizing a Coanda effect to obtain a comparative toner particle 7.

### Production of Toner 1

To 98.0 parts of the toner particle 1, 2.0 parts of a silica fine particle (a hydrophobically treated product with hexamethyldisilazane, the number-average particle diameter of primary particles: 10 nm, BET specific surface area: 170 m²/g) as an external additive were added, and the mixture was mixed using a Henschel mixer (manufactured by Nippon Coke & Engineering Co., Ltd.) at 3000 rpm for 15 minutes to prepare a toner 1. The physical properties of the toner 1 obtained are shown in Tables 4 and 5.

### Production of Toners 2 to 27 and Comparative Toners 1 to 7

External addition was performed on the toner particles 2 to 27 and the comparative toner particles 1 to 7 in the same conditions as in the production or the toner 1 to prepare toners 2 to 27 and the comparative toners 1 to 7.

Physical properties of the resulting toners are shown in Tables 4 and 5.

TABLE 3

| | | Binder resin | | | | | |
|---|---|---|---|---|---|---|---|
| | | Crystalline resin | | Amorphous resin | | Polymerizable | |
| | | | Amount | | Amount | | Amount |
| Toner | Production | | added | | added | | added |
| No. | method | Type | (parts) | Type | (parts) | Type | (parts) |
| Toner 1 | A | Crystalline vinyl resin 1 | 40.0 | Amorphous polyester resin 1 | 6.0 | Styrene | 45.0 |
| Toner 2 | A | Crystalline vinyl resin 2 | 20.0 | Amorphous polyester resin 2 | 4.0 | Styrene | 60.0 |
| Toner 3 | A | Crystalline vinyl resin 3 | 30.0 | Amorphous polyester resin 3 | 6.0 | Styrene | 52.5 |
| Toner 4 | A | Crystalline vinyl resin 4 | 30.0 | Amorphous polyester resin 3 | 6.0 | Styrene | 52.5 |
| Toner 5 | A | Crystalline vinyl resin 5 | 30.0 | Amorphous polyester resin 3 | 6.0 | Styrene | 52.5 |
| Toner 6 | A | Crystalline vinyl resin 6 | 30.0 | Amorphous polyester resin 3 | 8.0 | Styrene | 52.5 |
| Toner 7 | A | Crystalline vinyl resin 6 | 30.0 | Amorphous polyester resin 4 | 10.0 | Styrene | 52.5 |
| Toner 8 | A | Crystalline vinyl resin 6 | 30.0 | Amorphous polyester resin 5 | 3.0 | Styrene | 52.5 |
| Toner 9 | A | Crystalline vinyl resin 6 | 30.0 | Amorphous polyester resin 5 | 3.0 | Styrene | 52.5 |
| Toner 10 | A | Crystalline vinyl resin 6 | 30.0 | Amorphous polyester resin 6 | 2.0 | Styrene | 52.5 |
| Toner 11 | A | Crystalline vinyl resin 6 | 30.0 | Amorphous polyester resin 7 | 2.0 | Styrene | 52.5 |
| Toner 12 | A | Crystalline vinyl resin 6 | 30.0 | Amorphous polyester resin 8 | 1.5 | Styrene | 52.5 |
| Toner 13 | A | Crystalline vinyl resin 6 | 35.0 | Amorphous polyester resin 8 | 1.5 | Styrene | 48.8 |
| Toner 14 | A | Crystalline vinyl resin 6 | 20.0 | Amorphous polyester resin 9 | 6.0 | Styrene | 60.0 |
| Toner 15 | A | Crystalline vinyl resin 6 | 20.0 | Amorphous polyester resin 10 | 6.0 | Styrene | 60.0 |
| Toner 16 | A | Crystalline vinyl resin 6 | 20.0 | Amorphous polyester resin 11 | 6.0 | Styrene | 60.0 |
| Toner 17 | A | Crystalline vinyl resin 6 | 20.0 | Amorphous polyester resin 12 | 6.0 | Styrene | 60.0 |
| Toner 18 | A | Crystalline vinyl resin 7 | 30.0 | Amorphous polyester resin 13 | 6.0 | Styrene | 52.5 |
| Toner 19 | A | Crystalline vinyl resin 8 | 30.0 | Amorphous polyester resin 14 | 6.0 | Styrene | 52.5 |
| Toner 20 | A | Crystalline vinyl resin 5 | 30.0 | Amorphous polyester resin 15 | 6.0 | Styrene | 52.5 |
| Toner 21 | A | Crystalline vinyl resin 5 | 45.0 | Amorphous polyester resin 12 | 6.0 | Styrene | 41.3 |
| Toner 22 | A | Crystalline vinyl resin 5 | 15.0 | Amorphous polyester resin 12 | 6.0 | Styrene | 63.8 |
| Toner 23 | A | Crystalline vinyl resin 9 | 30.0 | Amorphous polyester resin 16 | 6.0 | Styrene | 52.5 |
| Toner 24 | A | Crystalline vinyl resin 10 | 50.0 | Amorphous polyester resin 17 | 6.0 | Styrene | 37.5 |
| Toner 25 | A | Crystalline vinyl resin 11 | 10.0 | Amorphous polyester resin 17 | 3.0 | Styrene | 67.5 |
| Toner 26 | A | Crystalline vinyl resin 12 | 10.0 | Amorphous polyester resin 18 | 3.0 | Styrene | 67.5 |
| Toner 27 | B | Crystalline vinyl resin 8 | 30.0 | Amorphous polyester resin 1 | 8.0 | Amorphous vinyl resin 1 | |
| Comparative Toner 1 | A | Crystalline vinyl resin 9 | 30.0 | Amorphous polyester resin 16 | 5.0 | Styrene | 52.5 |
| Comparative Toner 2 | A | Crystalline vinyl resin 7 | 30.0 | Amorphous polyester resin 19 | 15.0 | Styrene | 52.5 |
| Comparative Toner 3 | A | Crystalline vinyl resin 9 | 50.0 | Amorphous polyester resin 18 | 3.0 | Styrene | 37.5 |
| Comparative Toner 4 | A | Crystalline vinyl resin 11 | 10.0 | Amorphous polyester resin 20 | 5.0 | Styrene | 67.5 |
| Comparative Toner 5 | A | Crystalline vinyl resin 12 | 50.0 | Amorphous polyester resin 21 | 5.0 | Styrene | 37.5 |
| Comparative Toner 6 | A | Crystalline vinyl resin 13 | 90.0 | Amorphous polyester resin 21 | 10.0 | Styrene | 7.5 |

| | | | | | | |
|---|---|---|---|---|---|---|
| Comparative Toner 7 | B | Crystalline viny resin 8 | 30.0 | Amorphous polyester resin 1 | 6.0 | Amorphous vinyl resin 1 |

| | Binder resin | | | | | | | | |
|---|---|---|---|---|---|---|---|---|---|
| | Polymerizable monomer 2 | | Release agent | | Crosslinking agent | | | | |
| | | Amount | | Amount | | Amount | Reaction condition | | |
| Toner | | added | | added | | added | Temperature | | Time |
| No. | Type | (parts) | Type | (parts) | Type | (parts) | (° C.) | pH | (h) |
| Toner 1 | n-Butyl acrylate | 15.0 | DP18 | 9.0 | HDDA | 0.1 | 76.0 | 8.0 | 6.0 |
| Toner 2 | n-Butyl acrylate | 20.0 | DP18 | 9.0 | HDDA | 0.1 | 76.0 | 8.0 | 6.0 |
| Toner 3 | n-Butyl acrylate | 17.5 | HNP51 | 9.0 | HDDA | 0.1 | 76.0 | 8.0 | 6.0 |
| Toner 4 | n-Butyl acrylate | 17.5 | DP18 | 9.0 | HDDA | 0.1 | 76.0 | 8.0 | 6.0 |
| Toner 5 | n-Butyl acrylate | 17.5 | DP18 | 9.0 | HDDA | 0.1 | 76.0 | 8.0 | 6.0 |
| Toner 6 | n-Butyl acrylate | 17.5 | DP18 | 9.0 | HDDA | 0.1 | 77.0 | 8.0 | 6.0 |
| Toner 7 | n-Butyl acrylate | 17.5 | DP18 | 9.0 | HDDA | 0.1 | 76.0 | 8.0 | 6.0 |
| Toner 8 | n-Butyl acrylate | 17.5 | DP18 | 9.0 | HDDA | 0.1 | 74.0 | 8.0 | 6.0 |
| Toner 9 | n-Butyl acrylate | 17.5 | DP18 | 9.0 | HDDA | 0.1 | 77.0 | 8.0 | 6.0 |
| Toner 10 | n-Butyl acrylate | 17.5 | DP18 | 9.0 | HDDA | 0.1 | 74.0 | 8.0 | 6.0 |
| Toner 11 | n-Butyl acrylate | 17.5 | DP18 | 9.0 | HDDA | 0.1 | 73.0 | 8.0 | 6.0 |
| Toner 12 | n-Butyl acrylate | 17.5 | DP18 | 9.0 | HDDA | 0.1 | 76.0 | 8.0 | 6.0 |
| Toner 13 | n-Butyl acrylate | 16.3 | DP18 | 9.0 | HDDA | 0.1 | 76.0 | 8.0 | 6.0 |
| Toner 14 | n-Butyl acrylate | 20.0 | DP18 | 9.0 | HDDA | 0.1 | 76.0 | 8.0 | 6.0 |
| Toner 15 | n-Butyl acrylate | 20.0 | DP18 | 9.0 | HDDA | 0.1 | 76.0 | 8.0 | 6.0 |
| Toner 16 | n-Butyl acrylate | 20.0 | DP18 | 9.0 | HDDA | 0.1 | 76.0 | 8.0 | 6.0 |
| Toner 17 | n-Butyl acrylate | 20.0 | DP18 | 9.0 | HDDA | 0.1 | 76.0 | 9.0 | 6.0 |
| Toner 18 | n-Butyl acrylate | 17.5 | DP18 | 9.0 | HDDA | 0.1 | 76.0 | 9.0 | 6.0 |
| Toner 19 | n-Butyl acrylate | 17.5 | DP18 | 9.0 | HDDA | 0.1 | 76.0 | 9.0 | 6.0 |
| Toner 20 | n-Butyl acrylate | 17.5 | DP18 | 9.0 | HDDA | 0.1 | 76.0 | 9.0 | 6.0 |
| Toner 21 | n-Butyl acrylate | 13.8 | DP18 | 9.0 | HDDA | 0.1 | 76.0 | 9.0 | 6.0 |
| Toner 22 | n-Butyl acrylate | 21.3 | DP18 | 9.0 | HDDA | 0.1 | 76.0 | 9.0 | 6.0 |
| Toner 23 | n-Butyl acrylate | 17.5 | DP18 | 9.0 | HDDA | 0.1 | 76.0 | 9.0 | 6.0 |
| Toner 24 | n-Butyl acrylate | 12.5 | DP18 | 9.0 | HDDA | 0.1 | 76.0 | 9.0 | 6.0 |
| Toner 25 | n-Butyl acrylate | 22.5 | DP18 | 9.0 | HDDA | 0.1 | 76.0 | 9.0 | 6.0 |
| Toner 26 | n-Butyl acrylate | 22.5 | DP18 | 9.0 | HDDA | 0.1 | 76.0 | 9.0 | 6.0 |
| Toner 27 | Amorphous vinyl resin 1 | 70.0 | DP18 | 9.0 | — | — | — | — | — |
| Comparative Toner 1 | n-Butyl acrylate | 17.5 | DP18 | 9.0 | HDDA | 0.1 | 76.0 | 5.5 | 6.0 |
| Comparative Toner 2 | n-Butyl acrylate | 17.5 | DP18 | 9.0 | HDDA | 0.1 | 76.0 | 9.0 | 6.0 |
| Comparative Toner 3 | n-Butyl acrylate | 12.5 | DP18 | 9.0 | HDDA | 0.1 | 76.0 | 8.0 | 6.0 |
| Comparative Toner 4 | n-Butyl acrylate | 22.5 | DP18 | 9.0 | HDDA | 0.1 | 76.0 | 8.0 | 6.0 |
| Comparative Toner 5 | n-Butyl acrylate | 12.5 | DP18 | 9.0 | HDDA | 0.1 | 76.0 | 5.5 | 6.0 |
| Comparative Toner 6 | n-Butyl acrylate | 2.5 | DP18 | 9.0 | HDDA | 0.1 | 76.0 | 5.5 | 6.0 |
| Comparative Toner 7 | Amorphous vinyl resin 1 | 70.0 | DP18 | 9.0 | — | — | — | — | — |

In the table, “reaction conditions” refer to conditions of polymerization reaction when a dispersion of toner particle is obtained. In the column of production method, “A” denotes suspension polymerization and “B” denotes pulverization method. The abbreviations in the tables are as follows.
HNP 51: Hydrocarbon wax, SP value=16.9 (manufactured by Nippon Seiro Co., Ltd.)
DP18: dipentaerythritol stearate wax, SP value=18.3 (manufactured by The Nisshin Oillio Group, Ltd.)
HDDA: 1,6-hexanediol diacrylate

TABLE 4

| | | | | | | Coverage ratio | | | |
|---|---|---|---|---|---|---|---|---|---|
| | | | SP(B) − | A(max)/ | d | of polyester | Monomer unit | | |
| | SP(A) | SP(B) | SP(A) | A(min) | (min) | resin | (A) | Monomer unit (B) | n |
| Toner 1 | 21.5 | 21.7 | 0.2 | 1.3 | 14 | 90 | Acrylonitrile | Dodecenylsuccinic acid | 21 |
| Toner 2 | 20.7 | 21.3 | 0.6 | 1.2 | 12 | 90 | Methacrylonitrile | Dodecenylsuccinic acid | 21 |
| Toner 3 | 20.2 | 21.5 | 1.2 | 1.3 | 14 | 90 | Acrylonitrile | Dodecenylsuccinic acid | 17 |
| Toner 4 | 20.5 | 21.5 | 1.0 | 1.6 | 14 | 90 | Acrylonitrile | Dodecenylsuccinic acid | 21 |
| Toner 5 | 20.5 | 21.5 | 1.0 | 1.3 | 14 | 92 | Acrylonitrile | Dodecenylsuccinic acid | 21 |
| Toner 6 | 20.2 | 21.5 | 1.2 | 1.2 | 16 | 94 | Acrylonitrile | Dodecenylsuccinic acid | 21 |
| Toner 7 | 20.2 | 21.5 | 1.2 | 1.3 | 18 | 96 | Acrylonitrile | Dodecenylsuccinic acid | 21 |
| Toner 8 | 20.2 | 21.5 | 1.2 | 1.8 | 6 | 85 | Acrylonitrile | Dodecenylsuccinic acid | 21 |
| Toner 9 | 20.2 | 21.5 | 1.2 | 2.8 | 5 | 65 | Acrylonitrile | Dodecenylsuccinic acid | 21 |
| Toner 10 | 20.2 | 21.5 | 1.2 | 2.3 | 8 | 75 | Acrylonitrile | Dodecenylsuccinic acid | 21 |
| Toner 11 | 20.2 | 21.5 | 1.2 | 1.9 | 8 | 85 | Acrylonitrile | Dodecenylsuccinic acid | 21 |
| Toner 12 | 20.2 | 21.5 | 1.2 | 2.1 | 7 | 75 | Acrylonitrile | Dodecenylsuccinic acid | 21 |
| Toner 13 | 20.2 | 21.5 | 1.2 | 2.4 | 7 | 70 | Acrylonitrile | Dodecenylsuccinic acid | 21 |
| Toner 14 | 20.2 | 21.5 | 1.2 | 1.4 | 14 | 90 | Acrylonitrile | Dodecenylsuccinic acid | 21 |
| Toner 15 | 20.2 | 21.5 | 1.2 | 1.4 | 14 | 90 | Acrylonitrile | Dodecenylsuccinic acid | 21 |
| Toner 16 | 20.2 | 21.5 | 1.2 | 1.3 | 14 | 90 | Acrylonitrile | Dodecenylsuccinic acid | 21 |
| Toner 17 | 20.2 | 21.5 | 1.2 | 2.2 | 14 | 85 | Acrylonitrile | Dodecenylsuccinic acid | 21 |
| Toner 18 | 19.6 | 21.1 | 1.4 | 2.4 | 14 | 85 | Acrylonitrile | Dodecerylsuccinic acid | 29 |
| Toner 19 | 21.3 | 22.3 | 1.0 | 2.4 | 14 | 85 | Acrylonitrile | Dodecenylsuccinic acid | 21 |
| Toner 20 | 20.5 | 22.5 | 2.0 | 2.5 | 14 | 85 | Acrylonitrile | Dodecenylsuccinic acid | 21 |
| Toner 21 | 20.5 | 21.5 | 1.0 | 2.5 | 14 | 90 | Acrylonitrile | Dodecenylsuccinic acid | 21 |
| Toner 22 | 20.5 | 21.5 | 1.0 | 1.8 | 14 | 90 | Acrylonitrile | Dodecenylsuccinic acid | 21 |
| Toner 23 | 21.5 | 22.1 | 0.6 | 2.7 | 14 | 75 | Acrylonitrile | — | 21 |
| Toner 24 | 20.7 | 22.1 | 1.4 | 2.9 | 14 | 70 | Acrylonitrile | — | 21 |
| Toner 25 | 22.5 | 22.1 | −0.4 | 2.7 | 10 | 70 | Acrylonitrile | — | 21 |
| Toner 26 | 19.4 | 20.9 | 1.4 | 1.4 | 10 | 70 | Acrylonitrile | — | 21 |
| Toner 27 | 21.3 | 21.7 | 0.4 | 1.5 | 18 | 95 | Acrylonitrile | Dodecenylsuccinic acid | 21 |
| Comparative Toner 1 | 21.5 | 22.1 | 0.6 | 3.2 | 4 | 50 | Acrylonitrile | — | 21 |
| Comparative Toner 2 | 19.6 | 22.1 | 2.5 | 1.0 | 20 | 95 | Acrylonitrile | — | 21 |
| Comparative Toner 3 | 21.5 | 22.1 | 0.6 | 3.5 | 10 | 60 | Acrylonitrile | — | 21 |
| Comparative Toner 4 | 22.5 | 20.9 | −1.6 | 4.0 | 15 | 75 | Acrylonitrile | — | 21 |
| Comparative Toner 5 | 19.4 | 22.3 | 2.9 | 3.5 | 15 | 85 | Acrylonitrile | — | 21 |
| Comparative Toner 6 | 18.8 | 22.5 | 3.7 | — | 18 | 95 | — | — | 21 |
| Comparative Toner 7 | 21.3 | 21.7 | 0.4 | 3.0 | 15 | 5 | Acrylonitrile | Dodecenylsuccinic acid | 21 |

In the table, “n” is an integer n in formula (A2).

TABLE 5

| | Proportion in binder resin | | | | | | |
|---|---|---|---|---|---|---|---|
| | WA | WB | WC | | Monomer | Monomer | Monomer |
| | (% by | (% by | (% by | | unit (A) | unit (B) | unit (A2) |
| | mass) | mass) | mass) | WA/WB | (% by mass) | (% by mass) | (% by mass) |
| Toner 1 | 37.7 | 5.7 | 56.6 | 6.7 | 3.8 | 1.1 | 22.6 |
| Toner 2 | 19.2 | 3.8 | 76.9 | 5.0 | 1.0 | 1.3 | 15.4 |
| Toner 3 | 28.3 | 5.7 | 66.0 | 5.0 | 2.8 | 1.7 | 19.8 |
| Toner 4 | 28.3 | 5.7 | 66.0 | 5.0 | 4.2 | 1.7 | 19.8 |
| Toner 5 | 28.3 | 5.7 | 66.0 | 5.0 | 4.2 | 1.7 | 19.8 |
| Toner 6 | 27.8 | 7.4 | 64.8 | 3.8 | 2.8 | 2.2 | 19.4 |
| Toner 7 | 27.3 | 9.1 | 63.6 | 3.0 | 2.7 | 2.7 | 19.1 |
| Toner 8 | 29.1 | 2.9 | 68.0 | 10.0 | 2.9 | 0.9 | 20.4 |
| Toner 9 | 29.1 | 2.9 | 68.0 | 10.0 | 2.9 | 0.9 | 20.4 |
| Toner 10 | 29.4 | 2.0 | 68.6 | 15.0 | 2.9 | 0.6 | 20.6 |
| Toner 11 | 29.4 | 2.0 | 68.6 | 15.0 | 2.9 | 0.6 | 20.6 |
| Toner 12 | 29.6 | 1.5 | 69.0 | 20.0 | 3.0 | 0.4 | 20.7 |
| Toner 13 | 34.5 | 1.5 | 64.0 | 23.3 | 3.4 | 0.4 | 24.1 |
| Toner 14 | 18.9 | 5.7 | 75.5 | 3.3 | 1.9 | 1.7 | 13.2 |
| Toner 15 | 18.9 | 5.7 | 75.5 | 3.3 | 1.9 | 1.7 | 13.2 |
| Toner 16 | 18.9 | 5.7 | 75.5 | 3.3 | 1.9 | 1.7 | 13.2 |
| Toner 17 | 18.9 | 5.7 | 75.5 | 3.3 | 1.9 | 1.7 | 13.2 |
| Toner 18 | 28.3 | 5.7 | 66.0 | 5.0 | 2.8 | 2.3 | 24.1 |
| Toner 19 | 28.3 | 5.7 | 66.0 | 5.0 | 7.1 | 0.6 | 14.2 |
| Toner 20 | 28.3 | 5.7 | 66.0 | 5.0 | 2.8 | 0.3 | 19.8 |
| Toner 21 | 42.5 | 5.7 | 51.9 | 7.5 | 4.2 | 1.7 | 29.7 |
| Toner 22 | 15.1 | 5.7 | 79.2 | 2.7 | 1.5 | 1.7 | 10.6 |
| Toner 23 | 28.3 | 5.7 | 66.0 | 5.0 | 8.5 | 0.0 | 17.0 |
| Toner 24 | 47.2 | 5.7 | 47.2 | 8.3 | 9.4 | 0.0 | 37.7 |
| Toner 25 | 9.7 | 2.9 | 87.4 | 3.3 | 3.4 | 0.0 | 4.4 |
| Toner 26 | 9.7 | 2.9 | 87.4 | 3.3 | 1.0 | 0.0 | 8.7 |
| Toner 27 | 27.8 | 7.4 | 64.8 | 3.8 | 6.9 | 1.5 | 13.9 |
| Comparative Toner 1 | 28.6 | 4.8 | 66.7 | 6.0 | 8.6 | 0.0 | 17.1 |
| Comparative Toner 2 | 17.4 | 13.0 | 69.6 | 1.3 | 1.7 | 0.0 | 10.4 |
| Comparative Toner 3 | 48.5 | 2.9 | 48.5 | 16.7 | 14.6 | 0.0 | 29.1 |
| Comparative Toner 4 | 9.5 | 4.8 | 85.7 | 2.0 | 3.3 | 0.0 | 4.3 |
| Comparative Toner 5 | 47.6 | 4.8 | 47.6 | 10.0 | 4.8 | 0.0 | 28.6 |
| Comparative Toner 6 | 81.8 | 9.1 | 9.1 | 9.0 | 0.0 | 0.0 | 73.6 |
| Comparalive Toner 7 | 28.6 | 4.8 | 66.7 | 6.0 | 7.1 | 1.0 | 14.3 |

In the table, WA indicates the mass proportion of a crystalline vinyl resin in the binder resin. WB indicates the mass proportion of an amorphous polyester resin in the binder resin. WC indicates the mass proportion of a styrenic vinyl resin in the binder resin.

### Example 1

For image evaluation, LBP-712Ci modified was used so that a process speed could be set to 400 mm/see and the temperature of the fixing unit could be set as desired.

A process cartridge filled with 200 g of the toner 1 was allowed to stand in a high temperature and high humidity environment at 30° C. and a humidity of 800% RH for 48 hours, and then an image for each evaluation was printed in a high temperature and high humidity environment at 30° C. and a humidity of 800% RH to evaluate the toner.

The transfer paper used was an A4 size paper sheet (“Prover Bond Paper”: 105 g/m², manufactured by Fox River). The toner application amount on the transfer paper was set to 0.80 mg/cm². The evaluation results are presented in Table 6.

### Toner Evaluating Method

### (1) Evaluation of Low-Temperature Fixability

An image pattern in which square images of 10 mm×10 mm were evenly arranged at 9 points on the whole transfer paper was printed. While raising the fixation temperature in 5° C. increments within the range of from 120° C. to 240° C., the fixing lower limit temperature and the fixing upper limit temperature were evaluated.

The fixed image was visually confirmed, and the lowest temperature at which cold offset did not occur was defined as the fixing lower limit temperature. The lower the fixing lower limit temperature, the better the low-temperature fixability. In the present disclosure, rank C or higher is judged to be good.

### Evaluation Criteria

A: The fixing lower limit temperature is 140° C. or lower.
B: The fixing lower limit temperature is from 145° C. to 155° C.
C: The fixing lower limit temperature is from 160° C. to 170° C.
D: The fixing lower limit temperature is 175° C. or higher.

### (2) Release Property

In the evaluation of (1), the maximum temperature at which hot offset did not occur was set as the fixing upper limit temperature, and the release property was evaluated from the difference between the fixing lower limit temperature and the fixing upper limit temperature. The larger the difference between the fixing lower limit temperature and the fixing upper limit temperature, the better the release property. In the present disclosure, rank C or higher is judged to be good.

### Evaluation Criteria

A: The difference between the fixing lower limit temperature and the fixing upper limit temperature is 30° C. or larger
B: The difference between the fixing lower limit temperature and the fixing upper limit temperature is from 20° C. to 25° C.
C: The difference between the fixing lower limit temperature and the fixing upper limit temperature is from 10° C. to 20° C.
D: The difference between the fixing lower limit temperature and the fixing upper limit temperature is smaller than 10° C.

### (3) Evaluation of Charge Rising Performance

After 100 sheets of solid images were printed under the environment described above, the density was measured at 9 points in the image, and the average density value was calculated. XRite eXact Advanced (manufactured by X-Rite, Inc.) was used for the density measurement. The smaller the difference in density between the 1st sheet and the 100th sheet, the better the charge rising performance. In the present disclosure, rank C or higher is judged to be good.

### Evaluation Criteria

A: The difference between the average density values of the 1st sheet and the 100th sheet is 0.03 or less.
B: The difference between the average density values of the 1st sheet and the 100th sheet is greater than 0.03 and 0.06 or less.
C: The difference between the average density values of the 1st sheet and the 100th sheet is greater than 0.06 and 0.09 or less.
D: The difference between the average density values of the 1st sheet and the 100th sheet is greater than 0.09.

### (4) Evaluation of Durability Test Density

After 10000 sheets of 1% text images were printed under the environment described above, one sheet of a solid-color image was printed. For the solid-color image on the 10001st sheet, the image density was measured at nine points within each image, and the average density value was calculated. XRite eXact Advanced (manufactured by X-Rite) was used for the density measurement.

The larger the average density value of the 10001st sheet is, the better the durability. In the present disclosure, rank C or higher is judged to be good.

### Evaluation Criteria

A: The difference between the average density values of the 1st sheet and the 10001st sheet is 1.30 or more.
B: The difference between the average density values of the 1st sheet and the 10001st sheet is 1.20 or more and smaller than 1.30.
C: The difference between the average density values of the 1st sheet and the 10001st sheet is 1.10 or more and smaller than 1.20.
D: The difference between the average density values of the 1st sheet and the 10001st sheet is smaller than 1.10.

### (5) Evaluation of Durability Test Streaks

After printing 10000 text images with a print density of 1% under the above conditions, 10 halftone (40H) images were printed. The number of white streaks on the 10 images thus obtained was visually measured, and the total number of white streaks in the 10 images was calculated. The total number of white streaks was evaluated based on the following criteria. In the present disclosure, rank C or higher is judged to be good.

### Evaluation Criteria

A: The number of white streaks is 3 or less
B: The number of white streaks is from 4 to 6
C: The number of white streaks is from 7 to 9
D: The number of white streaks is 10 or more

### Examples 2 to 27 and Comparative Examples 1 to 7

Examples 2 to 27 and Comparative Examples 1 to 7 were evaluated in the same manner as in Example 1. The evaluation results are presented in Table 6.

TABLE 6

| | | Low-temperature | | | | Charge rising | |
|---|---|---|---|---|---|---|---|
| | | fixability | | | | performance | |
| | | Fixing lower | | Release property | | Difference | |
| | | limit | | Difference in | | in density | |
| | | temperature | | temperature | | average | |
| | | (° C.) | Evaluation | (° C.) | Evaluation | value | Evaluation |
| Example 1 | Toner 1 | 125 | A | 40 | A | 0.01 | A |
| Example 2 | Toner 2 | 125 | A | 40 | A | 0.01 | A |
| Example 3 | Toner 3 | 125 | A | 25 | B | 0.01 | A |
| Example 4 | Toner 4 | 125 | A | 35 | A | 0.01 | A |
| Example 5 | Toner 5 | 125 | A | 30 | A | 0.01 | A |
| Example 6 | Toner 6 | 135 | A | 30 | A | 0.01 | A |
| Example 7 | Toner 7 | 145 | B | 30 | A | 0.01 | A |
| Example 8 | Toner 8 | 125 | A | 30 | A | 0.03 | A |
| Example 9 | Toner 9 | 120 | A | 20 | B | 0.06 | B |
| Example 10 | Toner 10 | 125 | A | 25 | B | 0.06 | B |
| Example 11 | Toner 11 | 125 | A | 30 | A | 0.04 | B |
| Example 12 | Toner 12 | 125 | A | 30 | A | 0.05 | B |
| Example 13 | Toner 13 | 120 | A | 20 | B | 0.06 | B |
| Example 14 | Toner 14 | 135 | A | 30 | A | 0.01 | A |
| Example 15 | Toner 15 | 145 | B | 30 | A | 0.01 | A |
| Example 16 | Toner 16 | 125 | A | 30 | A | 0.01 | A |
| Example 17 | Toner 17 | 125 | A | 25 | B | 0.05 | B |
| Example 18 | Toner 18 | 125 | A | 20 | B | 0.06 | B |
| Example 19 | Toner 19 | 125 | A | 20 | B | 0.05 | B |
| Example 20 | Toner 20 | 125 | A | 20 | B | 0.04 | B |
| Example 21 | Toner 21 | 120 | A | 25 | B | 0.06 | B |
| Example 22 | Toner 22 | 145 | B | 30 | A | 0.02 | A |
| Example 23 | Toner 23 | 125 | A | 20 | B | 0.04 | B |
| Example 24 | Toner 24 | 120 | A | 15 | C | 0.09 | C |
| Example 25 | Toner 25 | 170 | C | 30 | A | 0.06 | B |
| Example 26 | Toner 26 | 155 | B | 10 | C | 0.07 | C |
| Example 27 | Toner 27 | 135 | A | 25 | B | 0.06 | B |
| Comparative Example 1 | Comparative Toner 1 | 125 | A | 20 | B | 0.06 | B |
| Comparative Example 2 | Comparative Toner 2 | 180 | D | 20 | B | 0.04 | B |
| Comparative Example 3 | Comparative Toner 3 | 120 | A | 0 | D | 0.10 | D |
| Comparative Example 4 | Comparative Toner 4 | 180 | D | 15 | C | 0.04 | B |
| Comparative Example 5 | Comparative Toner 5 | 145 | B | 25 | B | 0.11 | D |
| Comparative Example 6 | Comparative Toner 6 | 150 | B | 0 | D | 0.01 | A |
| Comparative Example 7 | Comparative Toner 7 | 125 | A | 15 | C | 0.15 | D |

| | | Durability density Density streaks | | | |
|---|---|---|---|---|---|
| | | Average | | The number | |
| | | density | | of white | |
| | | value | Evaluation | streaks | Evaluation |
| Example 1 | Toner 1 | 1.42 | A | 0 | A |
| Example 2 | Toner 2 | 1.48 | A | 0 | A |
| Example 3 | Toner 3 | 1.45 | A | 1 | A |
| Example 4 | Toner 4 | 1.34 | A | 2 | A |
| Example 5 | Toner 5 | 1.33 | A | 2 | A |
| Example 6 | Toner 6 | 1.36 | A | 1 | A |
| Example 7 | Toner 7 | 1.38 | A | 1 | A |
| Example 8 | Toner 8 | 1.26 | B | 3 | A |
| Example 9 | Toner 9 | 1.17 | C | 8 | C |
| Example 10 | Toner 10 | 1.21 | B | 6 | B |
| Example 11 | Toner 11 | 1.27 | B | 3 | A |
| Example 12 | Toner 12 | 1.27 | B | 4 | B |
| Example 13 | Toner 13 | 1.16 | C | 6 | B |
| Example 14 | Toner 14 | 1.38 | A | 2 | A |
| Example 15 | Toner 15 | 1.40 | A | 2 | A |
| Example 16 | Toner 16 | 1.27 | B | 2 | A |
| Example 17 | Toner 17 | 1.22 | B | 4 | B |
| Example 18 | Toner 18 | 1.23 | B | 5 | B |
| Example 19 | Toner 19 | 1.26 | B | 5 | B |
| Example 20 | Toner 20 | 1.24 | B | 7 | C |
| Example 21 | Toner 21 | 1.20 | B | 6 | B |
| Example 22 | Toner 22 | 1.27 | B | 2 | A |
| Example 23 | Toner 23 | 1.22 | B | 8 | C |
| Example 24 | Toner 24 | 1.14 | C | 9 | C |
| Example 25 | Toner 25 | 1.29 | B | 7 | C |
| Example 26 | Toner 26 | 1.13 | C | 4 | B |
| Example 27 | Toner 27 | 1.18 | C | 6 | B |
| Comparative Example 1 | Comparative Toner 1 | 1.15 | C | 12 | D |
| Comparative Example 2 | Comparative Toner 2 | 1.25 | B | 5 | B |
| Comparative Example 3 | Comparative Toner 3 | 1.08 | D | 14 | D |
| Comparative Example 4 | Comparative Toner 4 | 1.12 | C | 14 | D |
| Comparative Example 5 | Comparative Toner 5 | 1.12 | C | 16 | D |
| Comparative Example 6 | Comparative Toner 6 | 1.25 | B | 30 | D |
| Comparative Example 7 | Comparative Toner 7 | 1.12 | C | 26 | D |

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-055537, filed Mar. 28, 2025, which is hereby incorporated by reference herein in its entirety.

What is claimed is:

1. A toner comprising a toner particle that comprises a binder resin,
the binder resin comprising a crystalline vinyl resin and an amorphous resin;
the amorphous resin comprising an amorphous polyester resin;
the toner particle being covered with the amorphous polyester resin;
the crystalline vinyl resin comprising a monomer unit (A) represented by formula (A) below: 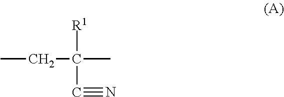
in formula (A), R¹ represents a hydrogen atom or a methyl group;
when an SP value of the crystalline vinyl resin is taken as SP(A) [(J/cm³)^{0.5}], the SP(A) is from 19.0 to 22.5 (J/cm³)^{0.5}; and
in a chart with an x-axis representing time and a y-axis representing ion amounts corresponding to the monomer unit (A), obtained by analyzing the toner particle while performing sputtering up to a sputtering time to remove 20 nm of a polymethyl methacrylate standard sample film in a time-of-flight secondary ion mass spectrometry (TOF-SIMS) using the toner particle as a sample,
when a maximum value of the ion amount is taken as A(max) and a minimum value of the ion amount is taken as A (min), the A(max) and the A (min) satisfy expression (1) below.
$$1. 0 < [ A ( max ) / A ( min ) ] \leq 3. \qquad ( 1 )$$

2. The toner according to claim 1, wherein, when an SP value of the amorphous polyester resin is taken as SP(B) [(J/cm³)^{0.5}], the SP(A) and the SP(B) satisfy expression (2) below.
$$- 1. \leq [ S P ( B ) - S P ( A ) ] < 1.5 \qquad ( 2 )$$

3. The toner according to claim 1, wherein the crystalline vinyl resin comprises 50.0 to 85.0% by mass of a monomer unit (A2) represented by formula (A2): 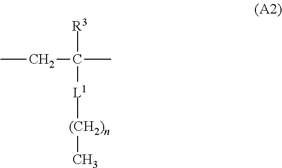
in formula (A2), R³ represents a hydrogen atom or a methyl group, L¹ represents a single bond, an ester bond, or an amide bond, and n represents an integer of from 15 to 30.

4. The toner according to claim 1, wherein
the amorphous resin further comprises a styrenic vinyl resin, and
a content of the styrenic vinyl resin in the binder resin is 45.0 to 85.0% by mass.

5. The toner according to claim 1, wherein the binder resin comprises 15.0 to 45.0% by mass of the crystalline vinyl resin.

6. The toner according to claim 1, wherein the amorphous polyester resin comprises a monomer unit (B) represented by formula (B) below: 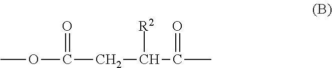
in formula (B), R² represents a C8-16 alkyl or alkenyl group.

7. The toner according to claim 6, wherein the amorphous polyester resin comprises 5.0 to 45.0% by mass of the monomer unit (B).

8. The toner according to claim 1, wherein
the crystalline vinyl resin comprises a monomer unit (A2) represented by formula (A2) below;
the amorphous polyester resin comprises a monomer unit (B) represented by formula (B);
a content proportion of the monomer unit (A2) in the binder resin is 5.0 to 30.0% by mass; and
a content proportion of the monomer unit (B) in the binder resin is 0.5 to 4.0% by mass: 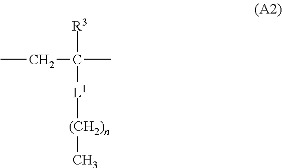
in formula (A2), R³ represents a hydrogen atom or a methyl group, L¹ represents a single bond, an ester bond, or an amide bond, and n represents an integer of from 15 to 30; and 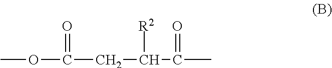
in formula (B), R² represents a C8-16 alkyl or alkenyl group.

9. The toner according to claim 1, wherein the amorphous polyester resin comprises a monomer unit corresponding to trimellitic acid or trimellitic anhydride.

10. The toner according to claim 1, wherein a weight-average molecular weight of the amorphous polyester resin is from 8000 to 25000.

11. The toner according to claim 1, wherein,
when a mass proportion of the crystalline vinyl resin in the binder resin is taken as WA (% by mass) and
a mass proportion of the amorphous polyester resin in the binder resin is taken as WB (% by mass),
the WA and the WB satisfy expression (3) below.
$$3. < ( W A / W B ) < 20. \qquad ( 3 )$$

12. The toner according to claim 1, wherein an acid value of the amorphous polyester resin is from 3.0 to 20.0 mgKOH/g.

13. The toner according to claim 1, wherein
in a cross-section of the toner particle observed using a transmission electron microscope (TEM) after the toner particle has been stained with ruthenium,
when a peripheral length of the toner particle is taken as C2 and a length of a portion where the amorphous resin is observed among the peripheral length of the toner particle is taken as C1,
the C1 and the C2 satisfy expression (5) below.
$$( C 1 / C 2 ) \times 100 \geq 80. \qquad ( 5 )$$

14. The toner according to claim 1, wherein the binder resin comprises 3.5 to 10.00% by mass of the amorphous polyester resin.

15. The toner according to claim 1, wherein the crystalline vinyl resin comprises a monomer unit corresponding to N-vinyl-2-pyrrolidone.

16. The toner according to claim 1, wherein
in the chart obtained by time-of-flight secondary ion mass spectrometry (TOF-SIMS) of the toner,
when a time on the x-axis at which the A (min) is detected is converted into a thickness to sputter a polymethyl methacrylate standard sample film is taken as d (min),
a value of the d (min) is 5 nm or larger and smaller than 20 nm.

17. The toner according to claim 1, wherein the toner particle comprises an ester wax as a releasing agent.

18. The toner according to claim 17, wherein
when an SP value of the ester wax is taken as SP(D) [(J/cm³)^{0.5}]
the SP(D) is from 17.0 to 19.0.

19. The toner according to claim 1, comprising a core-shell structure composed of
a core comprising the crystalline vinyl resin and the amorphous vinyl resin; and
a shell comprising the amorphous polyester resin, the shell covering the core.

20. The toner according to claim 1, wherein the A(max) and the A (min) satisfy expression (6) below.
$$1. 2 \leq [ A ( max ) / A ( min ) ] \leq 3. \qquad ( 6 )$$
